(19) United States
(12) Patent Application Publication
(10) Pub. No.: US 2013/0122432 A1
(43) Pub. Date: May 16, 2013

(54) CARBON DIOXIDE PURIFICATION

(71) Applicants: Ahmed Fouad Ghoniem, Winchester, MA (US); Randall Perkins Field, Andover, MA (US); Chukwunwike Ogbonnia Iloeje, Cambridge, MA (US)

(72) Inventors: Ahmed Fouad Ghoniem, Winchester, MA (US); Randall Perkins Field, Andover, MA (US); Chukwunwike Ogbonnia Iloeje, Cambridge, MA (US)

(73) Assignee: MASSACHUSETTS INSTITUTE OF TECHNOLOGY, CAMBRIDGE, MA (US)

(21) Appl. No.: 13/696,182

(22) PCT Filed: May 3, 2011
(86) PCT No.: PCT/US11/34948

§ 371 Date: Jan. 22, 2013

Related U.S. Application Data
(60) Provisional application No. 61/330,860, filed on May 3, 2010.

(51) Int. Cl. B01D 53/60; F23J 11/00

(52) U.S. Cl. CPC B01D 53/60; F23J 11/00
USPC 431/2; 423/235; 203/98; 202/153

(57) ABSTRACT

Systems and methods for the purification of carbon dioxide are provided. Also described are systems and methods of efficiently producing power using novel heat integration techniques, while producing carbon dioxide that is sufficiently pure to be sequestered. In some embodiments, a carbon dioxide-containing fluid stream is purified by removing NOₓ and SOₓ, using a single reactive absorption column. A carbon dioxide-containing fluid stream can be purified by removing one or more other contaminants (e.g., a non-condensable gas), in some instances.

### RELATED APPLICATIONS

This application claims priority under 35 U.S.C. §119(e) to U.S. Provisional Patent Application No. 61/330,860, filed May 3, 2010, and entitled “Carbon Dioxide Purification,” which is incorporated herein by reference in its entirety for all purposes.

### FIELD OF INVENTION

Systems and methods for the purification of carbon dioxide are generally described, which are particularly suited, in some embodiments, for processing the exhaust of oxy-combustion systems for carbon dioxide sequestration.

### BACKGROUND

Growing concerns over the impact of greenhouse gas emissions on the global climate have spurred widespread research studies focused on limiting carbon dioxide emissions. Many researchers have focused their efforts on the sequestration of carbon dioxide, which involves storing the carbon dioxide (e.g., in geological formations) after it has been produced in, for example, a fossil-fuel power production process. For sequestration applications, the concentration of contaminants such as NOₓ, SOₓ, O₂, and H₂O must be limited to avoid adverse consequences, such as, for example, corroding or otherwise damaging transport pipelines and/or storage areas. For these reasons, among others, there exists a need for effective systems and methods for purifying streams of carbon dioxide.

### SUMMARY OF THE INVENTION

Inventive systems and methods for the purification of carbon dioxide are described. Also described are systems and methods of reducing the parasitic energy load using novel heat integration techniques, while producing carbon dioxide that is sufficiently pure to be sequestered. The subject matter of the present invention involves, in some cases, interrelated products, alternative solutions to a particular problem, and/or a plurality of different uses of one or more systems and/or articles.

In one set of embodiments, a method of purifying a carbon dioxide containing fluid inlet stream by removing NOₓ and SOₓ is described. The method can comprise, in some embodiments, feeding the fluid inlet stream comprising carbon dioxide, NOₓ, and SOₓ to a single reactive absorption column; and within the single reactive absorption column, removing at least a portion of the NOₓ and SOₓ to create a fluid outlet stream enriched in carbon dioxide and lean in SOₓ relative to the fluid inlet stream, and comprising less than about 50 ppm NOₓ.

In some cases, the method can comprise feeding the fluid inlet stream comprising carbon dioxide, NOₓ, and SOₓ to a single reactive absorption column operated at a pressure of between about 20 bar and about 50 bar; and within the single reactive absorption column, removing at least a portion of the NOₓ and SOₓ to create a fluid outlet stream enriched in carbon dioxide, lean in SOₓ, and lean in NOₓ relative to the fluid inlet stream.

The method can comprise, in some instances, feeding the fluid inlet stream comprising carbon dioxide, NOₓ, and SOₓ to a single reactive absorption column; and within the single reactive absorption column, removing at least a portion of the NOₓ and SOₓ to create a fluid outlet stream enriched in carbon dioxide, lean in SOₓ, and lean in NOₓ relative to the fluid inlet stream, wherein the removal step comprises feeding an acid condensate stream to the absorption column, the acid condensate stream originating from a condenser unit upstream of the reactive absorption column relative to the fluid inlet stream.

In some embodiments, the method can comprise feeding the fluid inlet stream comprising carbon dioxide, NOₓ at a concentration of less than about 4000 ppm, and SOₓ to a single reactive absorption column; and within the single reactive absorption column, removing at least a portion of the NOₓ and SOₓ to create a fluid outlet stream enriched in carbon dioxide and lean in SOₓ relative to the fluid inlet stream, and comprising a molar concentration of NOₓ that is at least about 20 times smaller than the molar concentration of NOₓ in the fluid inlet stream.

In one set of embodiments, a method of purifying carbon dioxide is provided. The method can comprise feeding a fluid inlet stream comprising carbon dioxide and a contaminant to a distillation column to create a distillate stream comprising a first portion of the contaminant and a first portion of the carbon dioxide, wherein the distillate stream is enriched in the contaminant relative to the fluid inlet stream; forming from the distillate stream a vapor stream comprising a second portion of the contaminant and a second portion of the carbon dioxide; forming from the vapor stream a recycle stream comprising a third portion of the carbon dioxide; and transporting at least a portion of the recycle stream to the distillation column.

In some cases, the method can comprise feeding a fluid inlet stream comprising carbon dioxide and a contaminant to a distillation column to create a distillate stream comprising a first portion of the contaminant and a first portion of the carbon dioxide, wherein the distillate stream is enriched in the contaminant relative to the fluid inlet stream; forming from the distillate stream a vapor stream comprising a second portion of the contaminant and a second portion of the carbon dioxide; forming from the vapor stream a recycle stream comprising a third portion of the carbon dioxide; and performing a Joule-Thompson expansion of at least a portion of the recycle stream.

In one set of embodiments, a system for purifying carbon dioxide is described. The system can comprise a distillation column constructed and arranged to distill a fluid inlet stream comprising carbon dioxide and a contaminant to create a distillate stream comprising a first portion of the contaminant and a first portion of the carbon dioxide, wherein the distillate stream is enriched in the contaminant relative to the fluid inlet stream; a first separator fluidically connected to the distillation column constructed and arranged to form from the distillate stream a vapor stream comprising a second portion of the contaminant and a second portion of the carbon dioxide; a second separator fluidically connected to the first separator constructed and arranged to form from the vapor stream a recycle stream comprising a third portion of the carbon dioxide; and a fluidic pathway constructed and arranged to transport at least a portion of the recycle stream to the distillation column.

The system can comprise, in one set of embodiments, a distillation column constructed and arranged to distill a fluid inlet stream comprising carbon dioxide and a contaminant to create a distillate stream comprising a first portion of the contaminant and a first portion of the carbon dioxide, wherein the distillate stream is enriched in the contaminant relative to the fluid inlet stream; a first separator fluidically connected to the distillation column constructed and arranged to form from the distillate stream a vapor stream comprising a second portion of the contaminant and a second portion of the carbon dioxide; a second separator fluidically connected to the first separator constructed and arranged to form from the vapor stream a recycle stream comprising a third portion of the carbon dioxide; and an expander fluidically connected to the second separator constructed and arranged to perform Joule-Thompson expansion of at least a portion of the recycle stream.

In one set of embodiments, a method of combusting a fuel to produce a combustion exhaust stream and purifying carbon dioxide in the combustion exhaust stream is provided. In some cases, the method can comprise feeding an air stream to an air separation unit to produce a fluid oxidizing stream comprising between about 92 mol % and about 95 mol % oxygen; combusting a fuel in the presence of the fluid oxidizing stream within a combustor to produce a combustion exhaust stream comprising carbon dioxide; and purifying the combustion exhaust stream to produce a carbon dioxide containing stream comprising at least about 90 mol % carbon dioxide; wherein heat provided by the combustor is used to produce power from a power production unit, and wherein the overall system efficiency is at least about 98% of the overall system efficiency of a power system without the at least one carbon dioxide purification unit, but under otherwise essentially identical conditions.

In some instances, the method can comprise feeding an air stream to an air separation unit to produce a fluid oxidizing stream comprising between about 92 mol % and about 95 mol % oxygen; combusting a fuel in the presence of the fluid oxidizing stream within a combustor to produce a combustion exhaust stream comprising carbon dioxide; purifying the combustion exhaust stream to produce a carbon dioxide containing stream comprising at least about 90 mol % carbon dioxide; wherein heat provided by the combustor is used to produce power from a power production unit, and wherein the Rankine system efficiency is at least about 35%.

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIG. 1 includes a schematic illustration of a carbon dioxide purification system including a single reactive absorption column, according to one set of embodiments;

FIG. 2 includes an exemplary schematic illustration of a carbon dioxide purification system;

FIG. 3 includes a schematic illustration, according to some embodiments, of a power generation system comprising carbon dioxide purification;

FIG. 4A includes a schematic illustration of a carbon dioxide purification system including a single reactive absorption column, according to one set of embodiments;

FIGS. 4B-4F include the results of a sensitivity analysis performed for an exemplary single-column system;

FIG. 4G includes a schematic illustration of a dual-column carbon dioxide purification system, according to one set of embodiments;

FIGS. 5-9 include exemplary schematic illustrations of carbon dioxide purification systems; and

FIGS. 10A-10F include plots of the effects of various system parameters on the power and efficiency of an exemplary power production process.

### DETAILED DESCRIPTION

Inventive systems and methods for the purification of carbon dioxide are described. Also described are systems and methods of reducing the parasitic energy load using novel heat integration techniques, while producing carbon dioxide that is sufficiently pure to be sequestered. In at least a portion of the inventive carbon dioxide purification methods, a carbon dioxide-containing fluid stream is purified by removing NOₓ and SOₓ, using a single reactive absorption column.

In some cases, a fluid inlet stream containing carbon dioxide and at least one non-condensable gas is purified by feeding the fluid inlet stream to a gas separation unit operation. In one set of embodiments, the gas separation unit may comprise a distillation column that forms a distillate stream. In some cases, a vapor stream (and, optionally, a reflux stream) can be formed from the distillate stream, a portion of which can be further used to form a recycle stream comprising a portion of the carbon dioxide originally present in the fluid inlet stream. In some cases, at least a portion of the recycle stream can be transported to the distillation column, which can enhance the degree to which carbon dioxide is purified.

Heat integration may be used in certain embodiments to increase the efficiency with which carbon dioxide can be purified and/or the efficiency of other functions or unit operations of an inventive system. For example, at least a portion of the recycle stream mentioned above can be used in certain embodiments to perform a Joule-Thompson expansion, which can be used, for example, to provide cooling duty to another component of the system (e.g., a condenser used to recover CO₂ from a vapor stream, other heat exchanger, etc.). In addition, in some cases, the distillation column can be used to form a relatively cool bottoms stream (e.g., a carbon dioxide-rich bottoms stream), which can be used to pre-cool the mixture of carbon dioxide and non-condensable gases fed to the distillation column and/or can be made to undergo Joule-Thompson expansion to provide cooling duty to other system component(s).

Certain embodiments of the inventive systems and methods described herein can provide certain advantage(s) over traditional carbon dioxide purification techniques in certain applications. For example, in some embodiments, the amounts of NOₓ and SOₓ within a carbon dioxide containing stream can be reduced to very low levels using a single reactive absorption column, thereby requiring significantly lower costs relative to systems that use two or more reactive absorption columns and relative to conventional and widely-deployed low-pressure systems, including Flue Gas Desulfurization (FGD) for SOₓ removal and Selective Catalytic Reduction (SCR) for NOₓ removal. In addition, the inventive systems and methods described herein may in certain embodiments be used to generate power at a relatively high efficiency while producing carbon dioxide sufficiently pure to be sequestered.

The carbon dioxide purification systems and methods described herein can be used in a variety of applications. For example, in some embodiments, the carbon dioxide containing stream that is to be purified can originate from an oxy-combustion plant (e.g., an oxy-coal combustion plant). The purified carbon dioxide stream produced by certain embodiments of the inventive systems and methods can, in some cases, be sequestered or used as part of an enhanced oil recovery (EOR) process or an enhanced gas recovery processes. The purified CO₂ stream can be used in other applications where carbon dioxide is a useful component such as, for example, soda production. It should be understood, however, that the inventive carbon dioxide purification systems and processes are not limited to the exemplary applications described herein, and may be used with any suitable system in which the removal of NOₓ, SOₓ, and/or non-condensable gases from a carbon dioxide containing stream is desired.

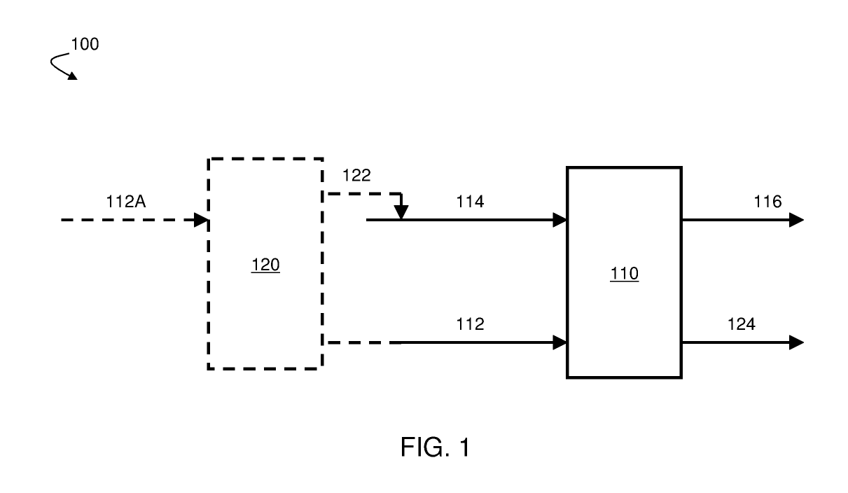

FIG. 1 shows a schematic illustration of a system 100 for purifying a carbon dioxide containing fluid inlet stream 112 using a single reactive absorption column 110, according to one set of embodiments. As used herein, the term “fluid” generally refers to a substance that is either in a liquid, gas, or supercritical state. Feed fluid stream 112 comprises carbon dioxide, NOₓ, and SOₓ. The term “NOₓ” is used to refer to nitrogen oxides and includes at least one of nitric oxide (NO), nitrogen dioxide (NO₂), and dinitrogen tetroxide (N₂O₄). In addition, the term “SOₓ” is used to refer to sulfur oxides and includes at least one of sulfur dioxide (SO₂) and sulfur triioxide (SO₃).

In some embodiments, the feed fluid stream to a carbon dioxide purification system/process of the invention may consist essentially of carbon dioxide, NOₓ, and SOₓ, while in other cases, the feed fluid stream may contain additional components (e.g., oxygen, nitrogen, carbon monoxide, argon, etc.). The inventive purification techniques described herein may be particularly useful for purifying carbon dioxide streams containing relatively low amounts of NOₓ (e.g., less than about 1.5 mol %, less than about 0.1 mol %, less than about 2000 parts per million (ppm), less than about 1000 ppm, between about 100 ppm and about 1.5 wt %, or between about 100 ppm and about 2000 ppm), which can require relatively expensive and/or complex systems to purify to sequestration standards using traditional methods. In some cases, the systems and methods can be used to purify carbon dioxide containing stream containing relatively low amounts of SOₓ (e.g., less than about 3 mol %, less than about 1.5 mol %, less than about 0.1 mol %, less than about 2000 parts per million (ppm), less than about 1000 ppm, between about 100 ppm and about 1.5 wt %, or between about 100 ppm and about 2000 ppm). It should be understood, however, that the invention is not so limited, and the carbon dioxide containing inlet stream can contain, in other embodiments, higher concentrations of NOₓ and/or SOₓ.

The carbon dioxide stream can originate from any suitable source. For example, in some cases, at least a portion of the carbon dioxide stream might originate from a combustion source, such as, for example, an oxy-combustion process (e.g., an oxy-coal combustion process) which can be used, for example, as part of a power production system. In some embodiments, the feed fluid stream can be pressurized to a pressure substantially greater than standard ambient pressure (e.g., at least about 5 bar, at least about 10 bar, at least about 20 bar, between about 5 bar and about 50 bar, between about 20 bar and about 50 bar, or between about 25 bar and about 35 bar) prior to introduction into the carbon dioxide purification system.

In the illustrated embodiment, water containing stream 114 is also fed to the reactive absorption column. The water within this stream can participate in one or more chemical reactions that results in the removal of NOₓ and/or SOₓ within the reactive absorption column, described in more detail below. The water containing stream can originate from any suitable source. In some cases, the water containing stream can originate from a stand alone water tank, pond, or other such source. In other embodiments, the water containing stream can originate from another process within a system comprising the reactive absorption column. For example, in some embodiments, carbon dioxide containing stream 112A can be fed to optional acid condenser 120 at a location upstream (relative to inlet stream 112) from the reactive absorption column. The acid condenser can be used to remove water and, in some cases, one or more components from stream 112A (e.g., one or more acids) to produce carbon dioxide containing stream 112 and water containing stream 122. In some embodiments, water containing stream 114 can comprise at least a portion of water containing stream 122 originating from the acid condenser. Such a pretreatment may be particularly advantageous when stream 112A comprises flue gas from a combustion/oxy-combustion process.

At least a portion of the NOₓ and/or SOₓ may be removed within the single reactive absorption column 110, in some instances, to create a fluid outlet stream 116 depleted in at least one of NOₓ or SOₓ. Reactive absorption columns in general are known to those of ordinary skill in the art, and, given a set of design specifications (including, for example, a desired throughput, residence time, operating pressure, and/or number of equilibrium stages within the absorber) and the guidance provided herein, those skilled in the art would be capable of constructing the absorption columns described herein as useful for practicing certain embodiments of the invention. In certain embodiments, a column containing a plurality of theoretical stages is employed for reactive absorption column 110. In certain embodiments, the column includes at least 9 theoretical stages or between about 7 stages and about 13 theoretical stages. One of ordinary skill in the art would be capable of determining the number of theoretical stages in a column based upon the actual number of stages by multiplying the actual number of stages by the stage efficiency. In certain embodiments, the reactive absorption column includes packing to enable multi-stage separations. In certain embodiments, the column will include at least 3 theoretical stages. In alternative embodiments, the column instead of being a packed column, may be a multi tray column. In yet other embodiments, the column may comprise both packing and trays.

Removal of SOₓ can be accomplished, in some instances, via a combination of the following gas phase reactions:

NO+1/2O₂→NO₂ [1]

2NO₂←→N₂O₄ [2]

NO₂+SO₂←→NO+SO₃ [3]

and/or the following liquid phase reaction:

SO₃+H₂O←→H₂SO₄ [4]

In some cases, removal of NOₓ can be accomplished via a combination of Reactions 1 and 2, the following interfacial reaction:

N₂O₄(g)←→N₂O₄(l) [5]

and the following liquid phase reactions:

N₂O₄+H₂O←→HNO₃+HNO₂ [6]

3HNO₂←→HNO₃+2NO+H₂O [7]

It may be advantageous, in some cases, for the reactive absorption column to be pressurized to a pressure substantially greater than standard ambient pressure (e.g., at least about 3 bar, at least about 10 bar, at least about 20 bar, between about 3 bar and about 50 bar, between about 20 bar and about 50 bar, or between about 25 bar and about 35 bar). One of ordinary skill in the art would recognize that such reactive absorption columns might require the use of one or more design features to accommodate such high operating pressures such as, for example, relatively thick walls, high pressure conduit connections, one or more emergency pressure relief valves, and the like.

In the set of embodiments illustrated in FIG. 1, fluid outlet stream 116 can be enriched in carbon dioxide, lean in SOₓ, and/or lean in NOₓ relative to carbon dioxide containing fluid inlet stream 112. In some cases, the concentration of NOₓ and/or SOₓ within the fluid outlet stream can be very low. For example, the concentration of NOₓ within the fluid outlet stream 116 can be less than about 50 ppm, less than about 20 ppm, less than about 10 ppm, between about 1 ppm and about 50 ppm, between about 1 ppm and about 20 ppm, or between about 1 ppm and about 10 ppm. In some instances, the molar concentration of NOₓ in the fluid outlet stream can be at least about 10 times, at least about 20 times, at least about 50 times, at least about 100 times, at least about 200 times, between about 5 times and about 200 times, between about 5 times and about 75 times, or between about 10 times and about 50 times smaller than the molar concentration of NOₓ in the fluid inlet stream. The concentration of SOₓ within the fluid outlet stream 116 can be, in some embodiments, less than about 50 parts per million (ppm), less than about 10 ppm, less than about 1 ppm, or the outlet stream can be substantially free of SOₓ. Moreover, in some cases, the molar concentration of SOₓ in the fluid outlet stream can be at least about 10 times, at least about 100 times, at least about 1000 times, or at least about 10,000 times smaller than the molar concentration of SOₓ in the fluid inlet stream.

In some instances, the step of removing at least a portion of the NOₓ and SOₓ from fluid inlet stream 112 can result in the formation of acidic stream 124. The acidic stream can contain, for example, any of the acidic products outlined in Equations 1-7 above such as, for example, sulfuric acid (H₂SO₄) and/or nitric acid (HNO₃).

In addition to or instead of removing NOₓ and/or SOₓ from a carbon dioxide containing stream, one or more other contaminants of a carbon dioxide containing stream can be removed in certain embodiments. In some cases, a carbon dioxide containing stream can contain one or more non-condensable gases. The phrase “non-condensable gas,” as used herein, refers to any gas that does not condense at temperatures above 123 K at atmospheric pressure (i.e., 1 atm) nor under the conditions expected to prevail in the gas separation system employed systems. A carbon dioxide containing stream can include, for example, non-condensable gases such as oxygen (O₂), nitrogen (N₂), argon (Ar), and/or carbon monoxide (CO).

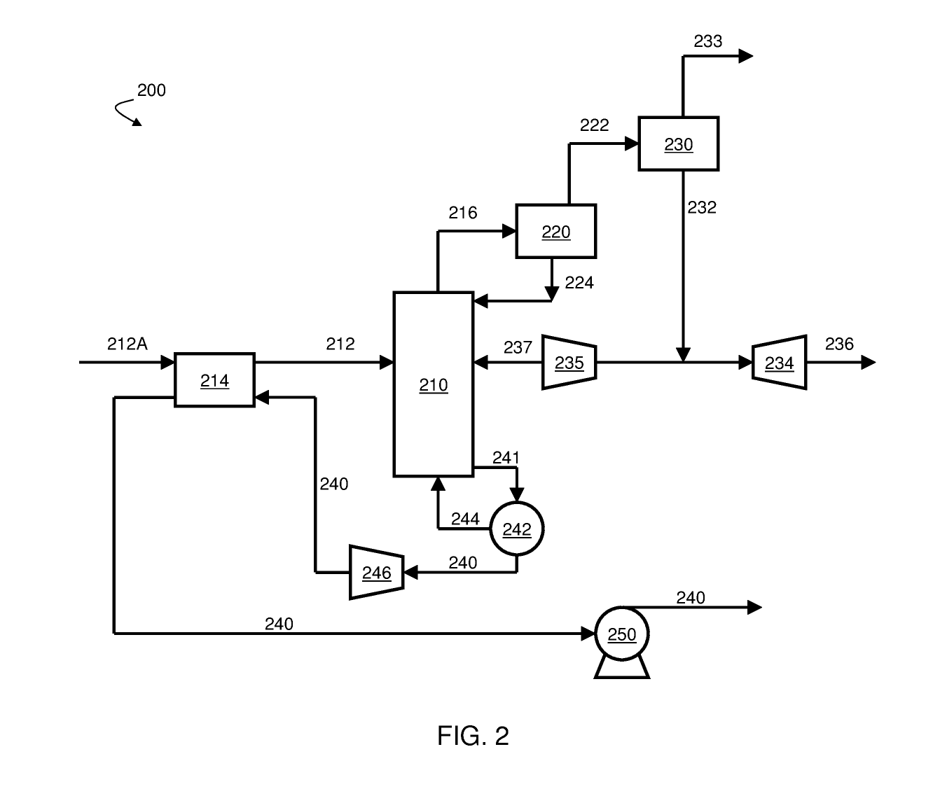

In some embodiments, a carbon dioxide containing stream containing at least one contaminant gas (e.g., one or more non-condensable gases) can be purified by feeding it to a distillation column. FIG. 2 shows a schematic illustration of a system 200 for purifying a carbon dioxide containing fluid inlet stream 212 using distillation column 210, according to one set of embodiments. Inlet stream 212 can originate from any suitable source. In some embodiments, inlet stream 212 can comprise at least a part of the exit stream from a NOₓ and/or SOₓ removal process (e.g., fluid outlet stream 116 in FIG. 1). At least a portion of the inlet stream 212 might originate, in some instances, from a combustion process, such as an oxy-coal combustion process (e.g., used, for example, as part of a power production system).

It can be advantageous, in some circumstances, to provide a relatively low-temperature inlet stream 212 to the distillation column. For example, in some embodiments in which it is desired to remove a contaminant with a relatively low boiling point relative to carbon dioxide (e.g., a non-condensable gas), relatively low temperatures can be used to condense the carbon dioxide prior to feeding it to column 210. Accordingly, in some cases, optional heat exchanger 214 can be used to cool carbon dioxide containing stream 212A to produce carbon dioxide liquid containing stream 212. Stream 212A may originate from any of the sources mentioned above with respect to stream 212.

The distillation column can be constructed and arranged to distill the fluid inlet stream comprising carbon dioxide and the contaminant gas(es) to create a distillate stream 216. One of ordinary skill in the art would be capable of constructing a distillation column, given a set of design parameters (e.g., number of stages, feed stage location, desired throughput, operational temperatures and pressures, etc.). In certain embodiments, the distillation column includes packing to enable multi-stage separations. In certain embodiments, the distillation column will include at least 3 theoretical stages. In alternative embodiments, the distillation column instead of being a packed column, may be a multi tray column. In yet other embodiments, the distillation column may comprise both packing and trays. The distillation column can include, in some cases, between 3 and 20 theoretical stages, or between 7 and 13 theoretical stages. One of ordinary skill in the art would be capable of determining the number of theoretical stages in a column based upon the actual number of stages by multiplying the actual number of stages by the stage efficiency.

In some cases, at least a part of the distillation column might be constructed and arranged to operate at relatively low temperatures (e.g., below about 0° C., below about −20° C.) or at relatively high pressures (e.g., above about 5 bar, above about 10 bar, above about 20 bar). One of ordinary skill in the art would be capable of providing suitable heat exchangers to achieve these low temperatures. In addition, one of ordinary skill in the art would be capable to designing the column (e.g., by incorporating relatively thick walls, by incorporating high-pressure fluidic connections, etc.) to withstand these relatively high pressures.

While the formation of a distillate stream using a distillation column has been primarily described, it should be understood that, in other embodiments, other unit operations can be used to form a purified carbon dioxide containing stream from the inlet stream. For example, in some cases, a membrane separation unit or a pressure swing absorption unit could be used in place of or in addition to the distillation column.

In the set of embodiments illustrated in FIG. 2, fluid inlet stream 212, including carbon dioxide and at least one contaminant, is fed to distillation column 210 to create distillate stream 216 containing a first portion of the contaminant and a first portion of the carbon dioxide. In some embodiments, distillate stream 216 can be enriched in the contaminant relative to fluid inlet stream 212, for example, if the contaminant has a relatively low boiling point relative to carbon dioxide.

A vapor stream comprising a second portion of the contaminant and a second portion of the carbon dioxide can be formed from the distillate stream, in some embodiments. The vapor stream can be relatively rich in contaminant, relative to the distillate stream, in some embodiments. Formation of the vapor stream can be achieved, for example, using a separator fluidically connected to the distillation column. Two components are said to be “fluidically connected” when they are constructed and arranged such that a fluid can flow between them. In some cases, two components can be “directly fluidically connected,” which is used to refer to a situation in which the two components are constructed and arranged such that a fluid can flow between without being transferred through a unit operation constructed and arranged to substantially change the temperature and/or pressure of the fluid. One of ordinary skill in the art would be able to differentiate between unit operations that are constructed and arranged to substantially change the temperature and/or pressure of a fluid (e.g., a compressor, a condenser, a heat exchanger, etc.) and components are not so constructed and arranged (e.g., a transport pipe through which incidental heat transfer and/or pressure accumulation may occur).

The set of embodiments illustrated in FIG. 2 includes a first separator 220 directly fluidically connected to the distillation column Separator 220 can be constructed and arranged to form, from distillate stream 216, vapor stream 222 comprising a second portion of the contaminant and a second portion of the carbon dioxide. In some cases, separator 220 can be constructed and arranged to form reflux stream 224 which can be, in some cases, relatively rich in carbon dioxide relative to distillate stream 216. The reflux stream can be, for example, fed to the top stage of the distillation column, as shown in FIG. 2. In other cases, the reflux stream might be transported to an intermediate stage of the distillation column. In still other cases, e.g. where the distillate stream 216 is compressed, the condenser (220) may exchange heat with the column reboiler.

Any suitable separator can be used to form vapor stream 222. In some embodiments, the separator can comprise a condenser. One of ordinary skill in the art, given a set of design parameters (e.g., temperature, pressure, heat duty, etc.), could select or construct a condenser suitable for use in forming vapor stream 222. In some cases, separator 220 can be the first condenser of a two-stage condenser.

A recycle stream 232 comprising a third portion of the contaminant and a third portion of the carbon dioxide may be formed from the vapor stream from the second separator, in some embodiments. Formation of the recycle stream 232 can be achieved, for example, using a second separator fluidically connected (e.g., directly fluidically connected) to the first separator. In the set of embodiments illustrated in FIG. 2, second separator 230 is directly fluidically connected to first separator 220. Separator 230 can be constructed and arranged to form, from vapor stream 222, recycle stream 232 comprising a third portion of the contaminant and a third portion of the carbon dioxide. In some cases, separator 230 can be constructed and arranged to also form a contaminant exit stream 233.

Any suitable separator can be used to form recycle stream 232. For example, the second separator can comprise a condenser in some cases (e.g., the second stage of a two-stage condenser). In some embodiments, the second separator can comprise a separate heat exchanger and flash drum. For example, the vapor stream 222 can be partially condensed in a heat exchanger (not shown in FIG. 2) to produce a two-phase stream which is then separated in a flash drum (also not shown in FIG. 2). An example of such a separation is illustrated in Examples 2-6. One of ordinary skill in the art, given a set of process parameters, could select or construct a condenser suitable for use in forming recycle stream 232.

Recycle stream 232 can be relatively cool and/or relatively highly pressurized. In some instances, a Joule-Thompson expansion can be performed on at least a portion of the recycle stream, which can generate a cold stream that can provide cooling duty elsewhere in the system. In the set of embodiments illustrated in FIG. 2, recycle stream 232 is fed to optional expander(s) 235 and/or 236 constructed and arranged to perform a Joule-Thompson expansion of at least a portion of recycle stream 232 to produce cooled stream 236 and/or 237. Cooled stream 236 can be used, for example, to provide cooling duty to a heat exchanger such as heat exchanger 214 used to cool fluid inlet stream 212A and/or a heat exchanger associated with separator 220 used to form vapor stream 222. In certain embodiments, substantially all of recycle stream 235 can be expanded via expander 234.

The recycle stream 232 can comprise the fluid product of the second separator and, in some embodiments, can be relatively rich in carbon dioxide relative to the vapor stream from the first separator. In some cases, at least a portion 237 of the recycle stream can be transported to the distillation column (e.g., an intermediate stage of the distillation column. For example, in the embodiments illustrated in FIG. 2, recycle stream 232 is transported from second separator 230 to an intermediate stage of distillation column 210. In some embodiments, at least a portion 237 of the recycle stream may have been compressed via optional compressor 235. Substantially all of recycle stream 232 can be compressed by compressor 235, in certain embodiments.

Referring back to the distillation column, in some cases, the fluid inlet stream can be separated within the distillation column to form the distillate stream and a bottoms stream (e.g., bottoms stream 240 in FIG. 2). The bottoms stream can be formed, for example, by passing bottom stage exit stream 241 through reboiler 242 to form column re-entry stream 244 and bottoms stream 240. In some instances, because the bottom stage exit stream is relatively high in pressure and/or low in temperature, reboiler 242 can function as an expander used to form a vapor stream (e.g., stream 244) and a liquid stream (e.g., bottoms stream 240).

In certain embodiments, the bottoms stream can be relatively cool and/or relatively highly pressurized. In some such cases, the bottoms stream can be used to provide cooling duty to another component of the system. In some embodiments, a Joule-Thompson expansion can be performed on at least a portion of the bottoms stream to further cool it for use elsewhere in the system. In the set of embodiments illustrated in FIG. 2, bottoms stream 240 is fed to optional expander 246 fluidically connected to the distillation column. Expander 246 can be constructed and arranged to perform a Joule-Thompson expansion of at least a portion of bottoms stream 240, further cooling the stream. The bottoms stream can be used, for example, to provide cooling duty to a heat exchanger such as, for example, heat exchanger 214 used to cool fluid inlet stream 212A (as illustrated in FIG. 2), a heat exchanger associated with separator 220 used to form vapor stream 222, and/or a heat exchanger associated with separator 230 used to form recycle stream 232.

The bottoms stream can be, in some instances, relatively rich in carbon dioxide relative to the fluid inlet stream. For example, in some embodiments, the bottoms stream can contain at least about 90 mol %, at least about 95 mol %, at least about 98 mol %, at least about 99 mol %, at least about 99.9 mol %, at least about 99.99 mol %, at least about 99.99 mol %, between about 90 mol % and about 99.999 mol %, between about 90 mol % and about 99.999 mol %, between about 95 mol % and about 99.999 mol %, between about 95 mol % and about 99.99 mol %, or between about 98 mol % and about 99.999 mol % carbon dioxide. In some instances, the molar concentration of the non-carbon dioxide components of the bottoms stream (e.g., the molar concentration of the non-condensable gases in the bottoms stream) can be at least about 10 times, at least about 100 times, at least about 1000 times, at least about 10,000 times, between about 10 times and about 10⁵ times, between about 100 times and about 10⁵, or between about 1000 times and about 10⁵ times smaller than the molar concentration of the non-carbon dioxide components in the fluid inlet stream.

After optionally providing a cooling load to another component of the system, bottoms stream 240 can be compressed to a pressure suitable for sequestration, in some cases, and pumped to the sequestration location via pump 250. While a single pump is illustrated in FIG. 2, it should be understood that the compression and pumping steps can be carried out using any suitable arrangement of compressors and/or pumps, which are known to those of ordinary skill in the art.

Some embodiments of the invention are directed to the use of one or more purification systems (e.g., system 100 of FIG. 1 and/or system 200 of FIG. 2) as part of an energy generation system. The energy generation system can be constructed and arranged to produce energy relatively efficiently while maintaining sufficiently high carbon dioxide purity in an exhaust stream such that the exhaust can be sequestered.

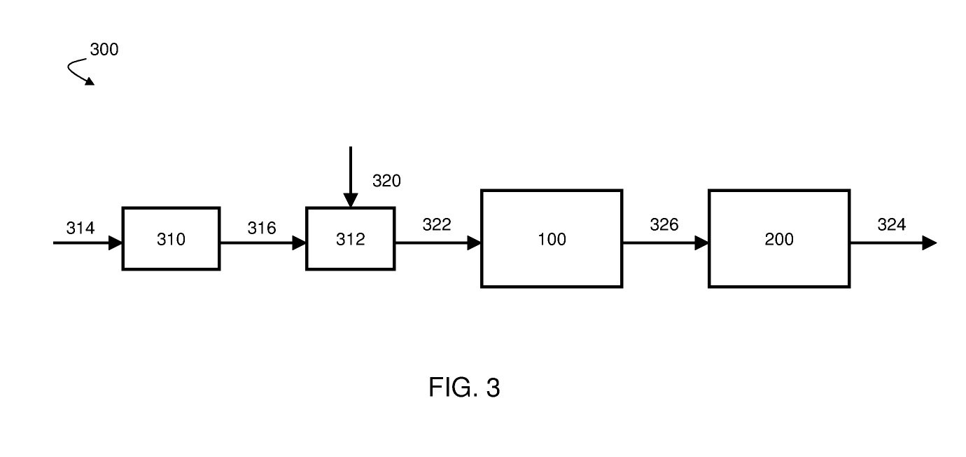

FIG. 3 includes a schematic illustration of an energy generation and carbon dioxide purification system, according to one set of embodiments. The set of embodiments illustrated in FIG. 3 includes an optional air separation unit 310 constructed and arranged to provide a fluid oxidizing stream to combustor 312. Air stream 314 (e.g., ambient air) can be fed to the air separation unit to produce a fluid oxidizing stream 316 rich in oxygen relative to the air stream. In some embodiments, the fluid oxidizing stream exiting the air separator can include a lower concentration of oxygen relative to traditional oxidizing streams used for similar purposes (e.g. for feeding a combustor in an oxy-combustion process). For example, the fluid oxidizing stream can comprise, in some cases, only between about 92 mol % and about 95 mol % oxygen.

Combustor 312 can be used as part of an energy generation process (e.g., in an oxy-combustion energy generation process, such as an oxy-coal combustion process). For examples, combustor 312 can be part of the energy generation process described in Hong, et al., “Analysis of Oxy-Fuel Combustion Power Cycle Utilizing a Pressurized Coal Combustor,” Energy, 2009, which is incorporated herein by reference. The combustor can be used to combust a fuel to produce heat, which can be used to produce power with a power production unit (e.g., by heating a stream of fluid that powers a turbine). In addition to oxidizing stream 316, fuel stream 320 may also be fed to combustor 312. Any suitable fuel can be used in system 300 including, but not limited to, coal, light or heavy oils, petcoke and other refinery products, biomass, waste streams, natural gas, and the like. The fuel can be combusted in the presence of the fluid oxidizing stream within the combustor to produce heat and a combustion exhaust stream 322 comprising carbon dioxide and NOₓ, SOₓ, and/or another contaminant (e.g. the non-condensable contaminant gases separated with system 200).

Combustion exhaust stream 322 can be purified to produce carbon dioxide stream 324. Carbon dioxide stream 324 can include a relatively high amount of carbon dioxide (e.g., at least about 95 mol %, at least about 98 mol %, at least about 99 mol %, at least about 99.9 mol %, at least about 99.99 mol %, at least about 99.99 mol %, between about 95 mol % and about 99.999 mol %, between about 95 mol % and about 99.99 mol %, or between about 98 mol % and about 99.999 mol % carbon dioxide).

In the set of embodiments illustrated in FIG. 3, carbon dioxide rich stream 324 is produced using system 100 to produce NOₓ and SOₓ lean intermediate stream 326, and using system 200 to produce carbon dioxide rich stream 324. It should be understood, however, that in some cases, only system 100 might be used (e.g., if relatively little nitrogen and oxygen are present in stream 322 or if the allowable non-condensable gas specifications are lenient), or only system 200 might be used (e.g., if relatively little NOₓ and SOₓ are present in stream 322). In embodiments in which both units 100 and 200 are used, combustion exhaust stream 324 can correspond to either of streams 112 and 112A in FIG. 1, intermediate stream 326 can correspond to either of streams 212 or 212A in FIG. 2, and/or carbon dioxide rich stream 324 can correspond to bottoms stream 240 in FIG. 2.

System 300 can be capable of achieving relatively high efficiencies, in some embodiments, despite the fact that relatively low amounts of oxygen might be present (e.g., between about 92 mol % and about 95 mol %) in oxidizing stream 316 and despite the fact that relatively pure carbon dioxide stream can be produced (e.g., at least about 90 mol %, at least about 95 mol %, at least about 98 mol %, at least about 99 mol %, at least about 99.9 mol %, at least about 99.99 mol %, between about 90 mol % and about 99.999 mol %, between about 90 mol % and about 99.99 mol %, between about 95 mol % and about 99.999 mol %, between about 95 mol % and about 99.99 mol %, between about 98 mol % and about 99.999 mol %, or between about 98 mol % and about 99.99 mol %).

In some embodiments, a purified carbon dioxide stream (e.g., at any of the purities mentioned in the preceding paragraph) can be produced and pressurized to a pressure of at least about 110 bar using a single-column NOₓ/SOₓ purification unit and/or a contaminant purification unit (e.g., a non-condensable gas purification unit), while maintaining an overall system efficiency that is at least about 98% of the overall system efficiency of a power system without the carbon dioxide purification units, but under otherwise essentially identical conditions. “Essentially identical conditions,” in this context, means conditions that are substantially the same or identical other than the use of the carbon dioxide purification system(s) (e.g., a single-column NOₓ/SOₓ purification unit and/or a contaminant (e.g., non-condensable gas) purification unit). For example, otherwise identical conditions may mean a power production system that is identical, but where it is not constructed to purify and compress carbon dioxide to at least about 110 bar (e.g., for sequestration). One of ordinary skill in the art would be capable of calculating the overall system efficiency as:

$$ɛ = \frac{{P}_{out} - {P}_{in , ASU} - {P}_{in , PPU} - {P}_{in , pur}}{{\dot{m}}_{fuel} \cdot {SE}_{fuel}} \qquad [ 8 ]$$

wherein Pₒᵤₜ is the power produced by the power production unit, P_{in,ASU} is the power input to the air separation unit, P_{in,PPU} is the power input to the power production unit, P_{in,pur} is the power input to the CO₂ purification system(s) including pressurizing the purified stream to at least about 110 bar, \dot{m}_{fuel} is the mass flow rate of the fuel, and SE_{fuel} is the specific energy (i.e., energy per unit mass based on the lower heating value) of the fuel.

In some cases, system 300 can be capable of achieving Rankine system efficiencies of at least about 35%, at least about 36%, or between about 35% and about 36.2% at any of the conditions mentioned herein. The Rankine system efficiency is generally calculated as:

$${ɛ}_{Rankine} = \frac{{P}_{out , Rankine} - {P}_{in , ASU} - {P}_{in , Rankine} - {P}_{in , pur}}{{\dot{m}}_{fuel} \cdot {SE}_{fuel}} \qquad [ 9 ]$$

wherein P_{out,Rankine} is the power produced when a supercritical Rankine cycle is employed as the power production unit, P_{in,ASU} is the power input to the air separation unit, P_{in,Rankine} is the power input to the supercritical Rankine cycle power production unit, P_{in,pur} is the power input to the CO₂ purification system(s) including pressurizing the purified stream to at least about 110 bar, \dot{m}_{fuel} is the mass flow rate of the fuel, and SE_{fuel} is the specific energy (i.e., energy per unit mass based on the lower heating value) of the fuel. In some embodiments, any of the above efficiency numbers can be achieved using coal as a fuel.

U.S. Provisional Patent Application No. 61/330,860, filed May 3, 2010, and entitled “Carbon Dioxide Purification” is incorporated herein by reference in its entirety for all purposes.

The following examples are intended to illustrate certain embodiments of the present invention, but do not exemplify the full scope of the invention.

### Example 1

This example describes a simulation of an exemplary single reactive absorption column NOₓ/SOₓ purification system. Oxy-combustion takes place in an environment consisting mainly of oxygen and recycled combustion gases. The product of combustion consists primarily of carbon dioxide and water, with contaminants like NOₓ and SOₓ (addressed in this example) and non-condensable gases like argon, oxygen and nitrogen (addressed in Examples 2-6). Most of the water in the oxy-combustion exhaust stream can be removed using an acid condenser, resulting in a CO₂-rich stream. Table 2 includes a typical flue gas composition for a pressurized oxy-coal combustion system leaving an acid condenser.

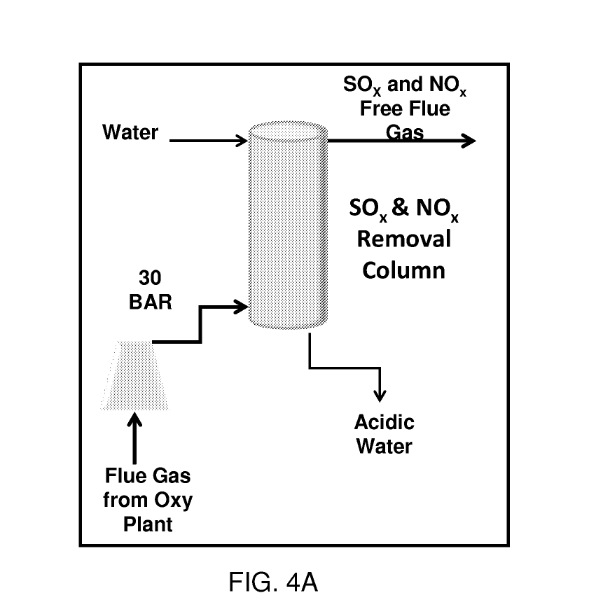

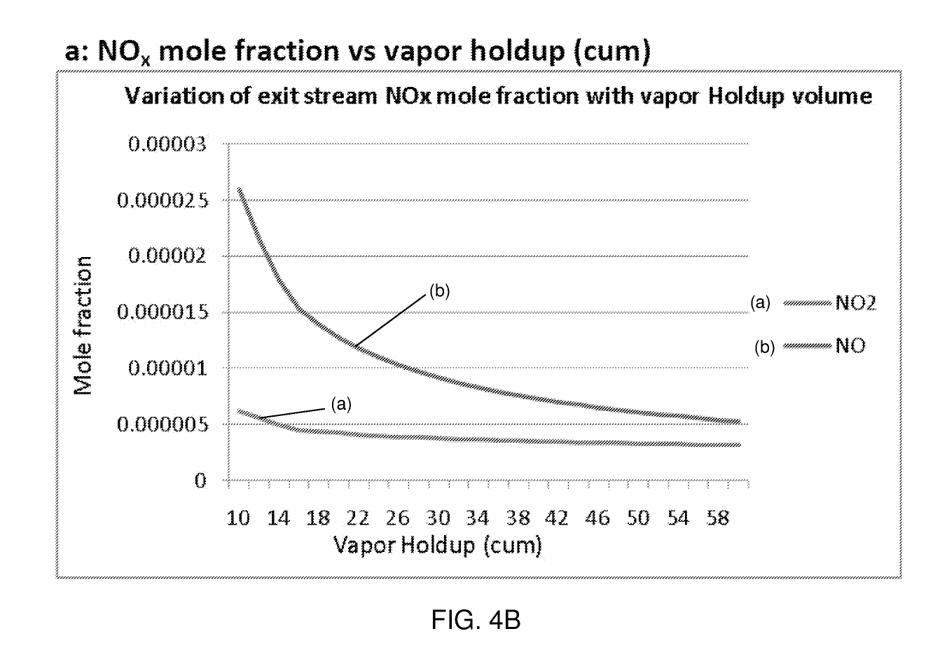

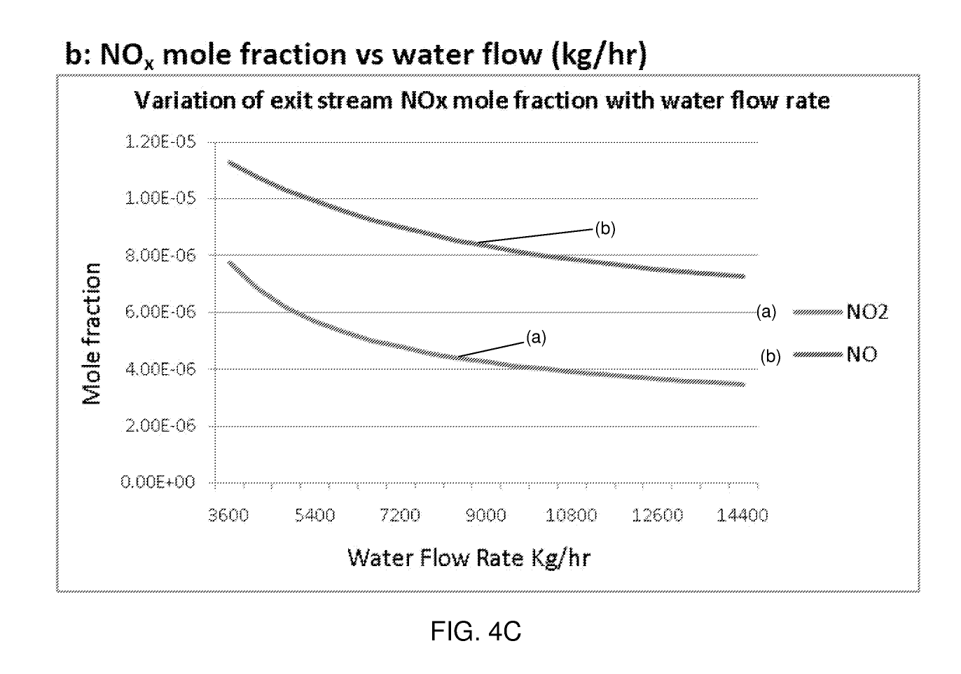

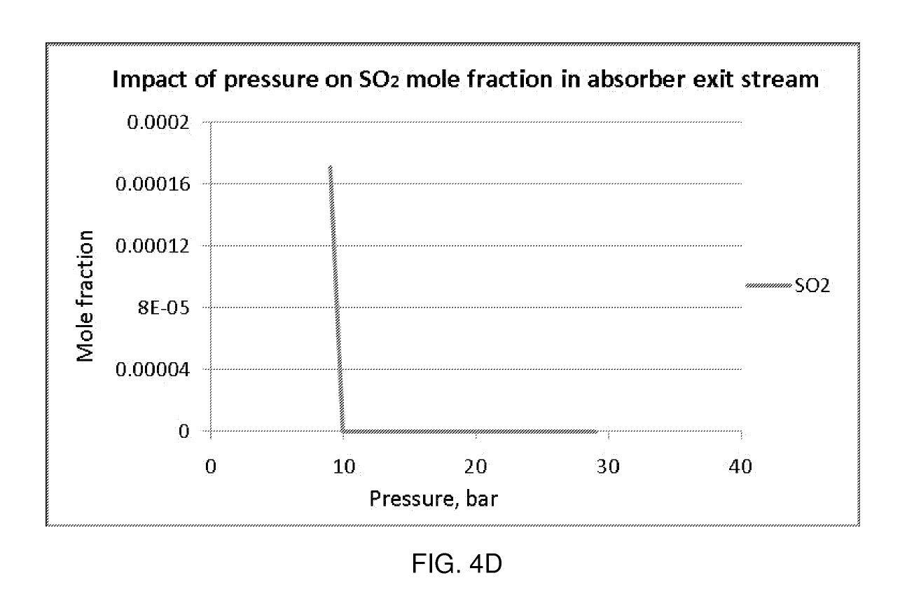

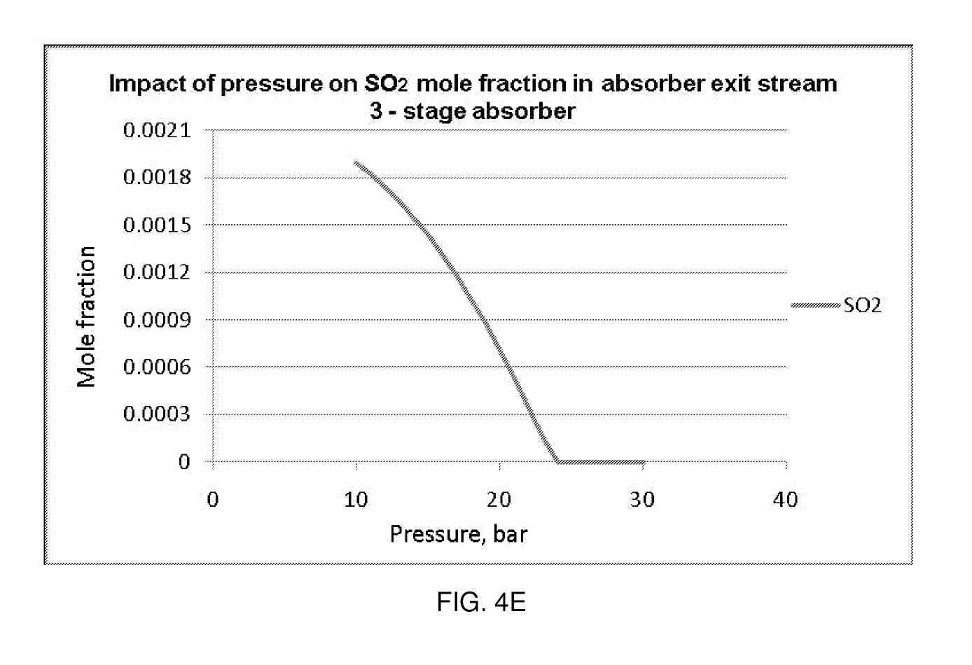

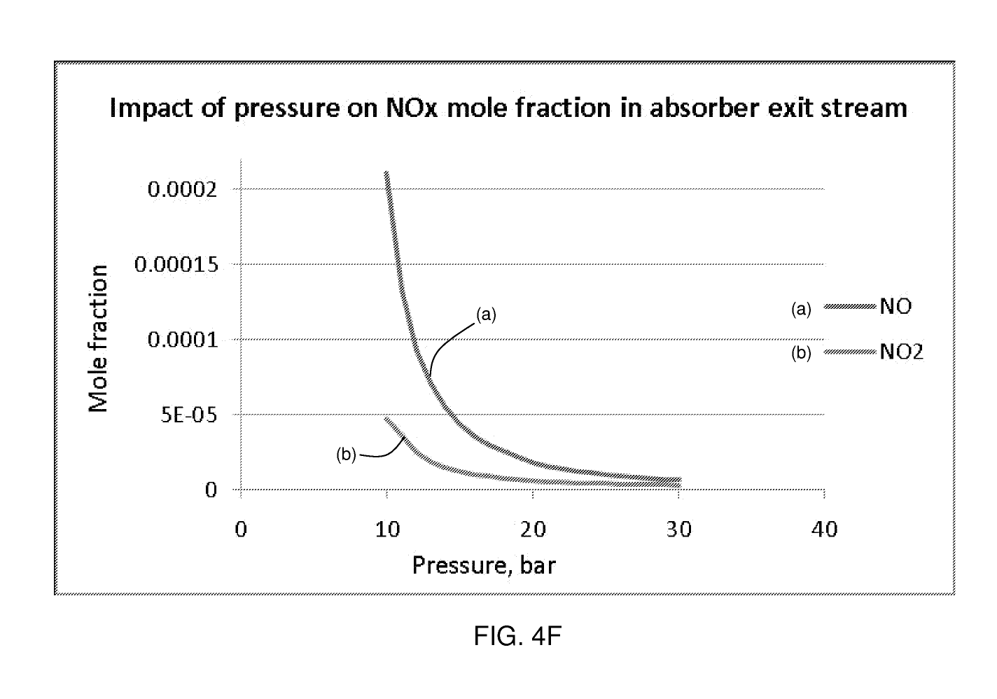

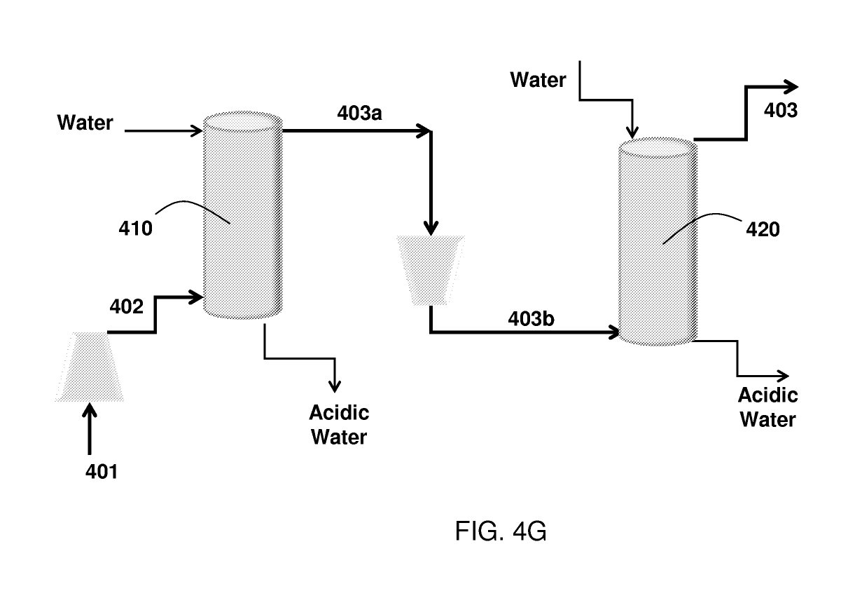

The single-column NOₓ and SOₓ removal system described in this example (and illustrated schematically in FIG. 4A) utilizes a single reactive absorber column operating at 30 bar. The single column outperforms a double column system (the simulation of which is described below) using fewer total column stages.

Aspen Plus version 7.1 (Aspen Technology, Inc.) was used to perform the simulations described in Examples 1-6. In addition, process inputs for Examples 1-6 were based upon the overall base power cycle described in detail in Hong, J., et al., “Analysis of Oxy-Fuel Combustion Power Cycle Utilizing a Pressurized Coal Combustor,” Energy, 2009. The base power cycle was a pressurized oxy-coal plant designed with a coal flow rate of 30 kg/s (HHV: 874.6 MWth, LHV: 839.1 MWth) with a flue gas flow rate of 87.4 kg/s, operating at a pressure of 10 bar.

The single-column NOₓ and SOₓ removal unit was simulated using the ElecNRTL Property Method, which is suitable for the dilute acid concentrations expected in the column. Table 1 includes the design parameters used for the reactive absorption column. Table 2 shows the CO₂ flue stream data. The design parameters were chosen to achieve NOₓ and SOₓ exit stream concentrations of less than about 10 ppm.

The use of acid condensate from an upstream acid condenser was also investigated as a means of reducing water usage by the oxy-fuel power plant. It was believed that such a design would be feasible, given that the acid concentration of this stream would be very low in practice and, therefore, would be suitable for use directly in the NOₓ and SOₓ removal column. Table 3 includes the results of a simulation obtained using the same column and inlet specifications outlined in Tables 1 and 2, but replacing fresh water with acid water. The composition of the acid water used to obtain the results in Table 3 is shown in Table 4.

TABLE 1
NOₓ and SOₓ removal column design parameters

| | |
|---|---|
| Operating Pressure | 30 bar |
| No. of Stages | 9 |
| Column Diameter | 3.3 m |
| Tray Type | Sieve |
| Tray Spacing | 0.6 m |
| Sieve hole submergence | 0.1 m |
| Holdup volume | 40 m³ |
| CO₂ Stream inlet Temperature | 25 C. |
| Water inlet Temperature | 25 C. |
| Water inlet stage | 1 (top) |
| CO₂ stream Inlet Stage | 9 (bottom) |
| Cooling | On stage 9 |
| Liquid Pump around | Optional |

TABLE 2
Mole fractions of the components in the CO₂ flue gas streams at the
inlet and outlet of the single column absorber. The inlet gas flow rate was
set to 87.4 kg/s

| Component | Inlet | Outlet |
|---|---|---|
| NO | 2.60E−04 | 5.30E−06 |
| NO₂ | 7.60E−05 | 2.40E−06 |
| N₂O₄ | 0 | 9.30E−10 |
| N₂ | 1.50E−02 | 1.50E−02 |
| O₂ | 5.70E−02 | 5.60E−02 |
| H₂O | 1.40E−02 | 1.50E−03 |
| SO₂ | 2.00E−03 | 0 |
| CO₂ | 8.60E−01 | 8.80E−01 |
| CO | 4.20E−04 | 4.30E−04 |
| Ar | 4.70E−02 | 4.70E−02 |

TABLE 3
Mole fractions of the components in the CO₂ flue gas streams at the
outlet of the single column absorber for simulations in which fresh water
and acid water were used. The inlet gas flow rate was set to 87.4 kg/s

| | Acid Water | Fresh Water |
|---|---|---|
| Component | Outlet | Outlet |
| NO | 7.90E−06 | 5.30E−06 |
| NO₂ | 9.90E−07 | 2.40E−06 |
| N₂O₄ | 1.60E−10 | 9.30E−10 |
| N₂ | 1.50E−02 | 1.50E−02 |
| O₂ | 5.60E−02 | 5.60E−02 |
| H₂O | 1.50E−02 | 1.50E−03 |
| SO₂ | 0 | 0 |
| CO₂ | 8.80E−01 | 8.80E−01 |
| CO | 4.20E−04 | 4.30E−04 |
| Ar | 4.70E−02 | 4.70E−02 |

TABLE 4
Mole fractions of the components in the acid water inlet.

| Component | |
|---|---|
| N₂ | 2.10E−06 |
| O₂ | 6.47E−06 |
| H₂O | 0.998065 |
| H₃O⁺ | 0.000116 |
| CO₂ | 0.001646 |
| H2SO₄ | 2.31E−25 |
| SO₂ | 4.99E−05 |
| SO₃ | 3.61E−40 |
| HSO₄⁻ | 3.01E−14 |
| SO₄⁻⁻ | 6.25E−14 |

A sensitivity analysis was performed to determine the impact of vapor holdup, water flow rate and pressure on column performance. From FIG. 4B and FIG. 4C, it can be seen that the column performance was more sensitive to holdup volume (which determines residence time) than water flow rate, though both increased the degree of removal of NOₓ. The relatively flat response of the NO₂ curve was a result of the from the fact that NO₂ was simultaneously generated and consumed.

FIGS. 4D-4E illustrate the impact of operating pressure on SO₂ mole fraction at the exit of the absorber column FIG. 4D shows that at slightly above 10 bar, all the SO₂ is removed in a 9-stage column. Further analysis showed that for a 3-stage column with the same parameters, all of the SO₂ is knocked out at 25 bar (FIG. 4E).

Adopting the single column design can lead to savings in process energy requirements as well as equipment cost. In addition, the pressure sensitivity plot (FIG. 4F) indicated that the difference in purity between 27 bar and 30 bar was relatively small. Therefore the column could also be operated at 27 bar and still yield less than 10 ppm of NOₓ and SOₓ in the exit composition.

For purposes of comparison, a simulation was also performed using a dual-reactive absorption column system, as illustrated schematically in FIG. 4G. The first column (including 5 stages) was operated at a pressure of 15 bar, while the second column (including 7 stages) was operated at a pressure of 30 bar. The two stage process includes carbon dioxide containing inlet stream 401 (e.g., flue gas from a oxy-coal combustion plant). In FIG. 4G, stream 401 is compressed to a pressure of about 15 bar to produce stream 402. Stream 402 is fed to a first reactive absorber column 410 to remove SOₓ, producing SOₓ lean stream 403a. Stream 403a is then compressed to a pressure of about 30 bar to produce stream 403b. Finally, stream 403b is treated in second reactive absorber column 420 to remove NOₓ to produce purified carbon dioxide stream 403. Table 5 includes the stream composition at the outlet (403 in FIG. 4G) of the two-stage process.

TABLE 5
Mole fractions of the components in the outlet of the two-column
SOₓ/NOₓ process.

| Component | Outlet |
|---|---|
| NO | 5.70E−06 |
| NO₂ | 2.40E−06 |
| N₂O₄ | 1.50E−09 |
| N₂ | 1.50E−02 |
| O₂ | 5.60E−02 |
| H₂O | 1.00E−03 |
| SO₂ | 0 |
| CO₂ | 8.80E−01 |
| CO | 4.30E−04 |
| Ar | 4.70E−02 |

From Table 5, it can be seen at the two-column process removed similar amounts of SOₓ, and removed less NOₓ, relative to the single-column process. The power requirements of the single-column and dual-column processes were also compared. It was determined that the dual-column arrangement required 7.22 MW of power to perform the separation, while the single-column arrangements only required 7.07 MW.

Finally, the effect of increasing the NOₓ and SOₓ concentrations in the flue gas on the performance of the single column system was investigated. Table 6 includes the inlet and outlet stream compositions for two simulations of the single-column process (a first simulation using Inlet 1 to produce Exit 1, and a second simulation using Inlet 2 to produce Exit 2) where relatively large concentrations of NOₓ and SOₓ, relative to the concentrations in the previous examples.

TABLE 6
Mole fractions of the components in the inlets and outlets of two
simulations of the single-column SOₓ/NOₓ process with relatively
high NOₓ and SOₓ inlet concentrations.

| Component | Inlet 1 | Exit 1 | Inlet 2 | Exit 2 |
|---|---|---|---|---|
| NO | 0.00417495 | 1.0994e−05 | 0.00432026 | 1.2726e−05 |
| NO2 | 0 | 4.5664e−06 | 0 | 5.6131e−06 |
| N2O4 | 0 | 3.1474e−09 | 0 | 3.9686e−09 |
| N2 | 0.16061714 | 0.16893365 | 0.16619639 | 0.16898159 |
| O2 | 0.04527429 | 0.04431226 | 0.04687676 | 0.04390486 |
| H2O | 0.03822285 | 0.00158892 | 0.00399791 | 0.00181973 |
| HNO3 | 0 | 2.9068e−08 | 0 | 4.4381e−08 |
| H3O+ | 0 | 0 | 0 | 0 |
| NO3− | 0 | 0 | 0 | 0 |
| CO2 | 0.71908858 | 0.75607059 | 0.74406745 | 0.75618853 |
| CO | 0 | 0 | 0 | 0 |
| AR | 0.02764869 | 0.02907897 | 0.02860868 | 0.02908690 |
| H2SO4 | 0.00476207 | 6.2142e−39 | 0.00486814 | 7.8802e−39 |
| SO2 | 0.00021140 | 4.3901e−30 | 0.00106438 | 2.3971e−30 |
| SO3 | 0.00417495 | 5.5969e−24 | 0 | 2.1505e−32 |

### Example 2

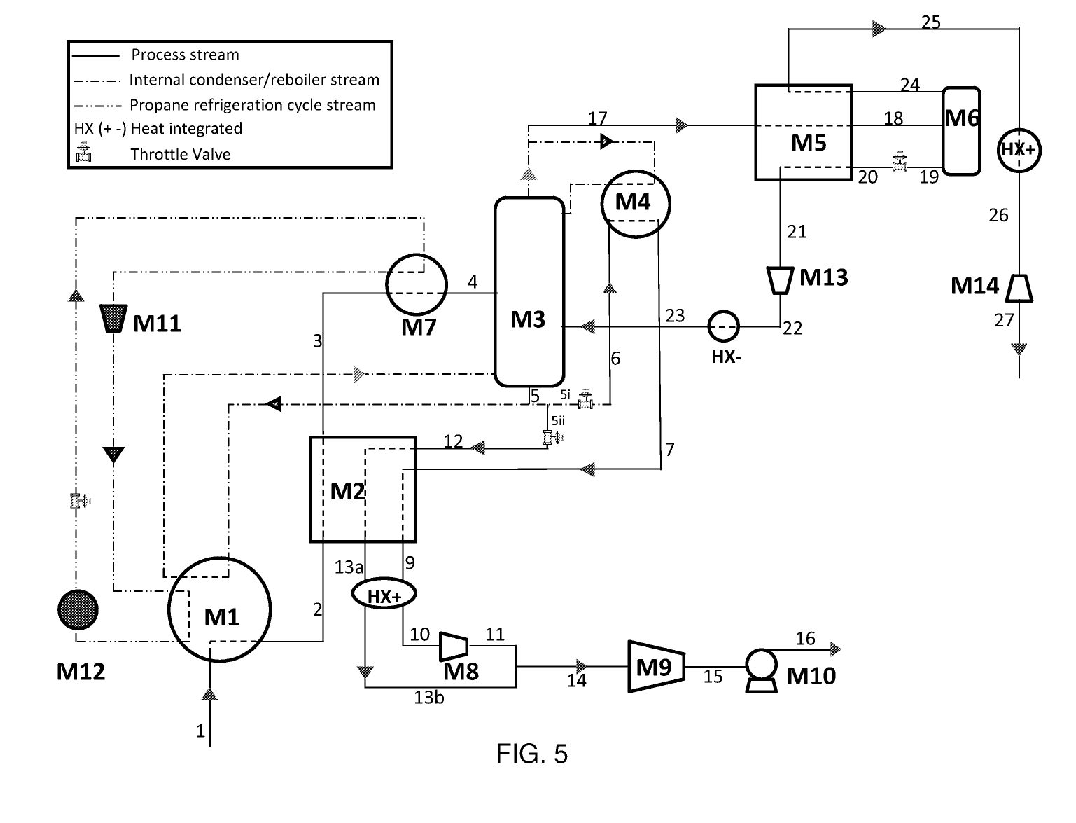

This example describes a simulation of a first system, illustrated in FIG. 5, used to purify a carbon dioxide stream to remove non-condensable gases. Table 7 includes a list of unit operation labels as used in the figures associated with Examples 2-6.

TABLE 7
Unit operation labels used in the figures associated with Examples 2-6.

| Label | Unit Operation |
|---|---|
| M1 | Reboiler |
| M2 | Cold Box for inlet CO₂ cooling |
| M3 | Distillation column |
| M4 | Condenser |
| M5 | Cold Box for distillate cooling |
| M6 | Flash drum |
| M7 | Propane refrigeration cycle evaporator for inlet |
| | CO₂ supplemental cooling |
| M8 | Compressor |
| M9 | Compressor |
| M10 | CO₂ Pump |
| M11 | Propane refrigeration cycle compressor |
| M12 | Propane refrigeration cycle condenser |
| M13 | Reflux CO₂ compressor |
| M14 | Expander |
| N1 | Cold Box for inlet CO₂ cooling |
| N2 | Distillation column |
| N3 | Vapor-Liquid Separator |
| N4 | Distillate compressor |
| N5 | Reboiler/1st stage Condenser |
| N6 | Cold Box-2nd stage Condenser |
| N7 | flash drum |
| N8 | Expander |
| N9 | Propane refrigeration cycle compressor |
| N10 | Propane refrigeration cycle condenser |
| N11 | CO₂ pump |

For the non-condensable gas removal units described in Examples 2-6, the RK-Aspen property method was selected. Since oxygen was considered to be the most important non-condensable contaminant (because of the stringent concentration restrictions usually applied to pipeline, EOR, and sequestration specifications), PTXY simulations were carried out for CO₂—O₂ binary systems, and the results were shown to be comparable to those described in the literature (See, e.g., Zenner, et al., Chem. Eng. Progr. Symp. Ser. 59, No. 44, 36 (1963); Muirbrook, et al., A.I.Ch.E. J., 11, 1092 (1965); and Fredenslund, et al., J. Chem. Eng. Data, 1970, 15 (1), pp 17-22). High predictive accuracy was achieved using data regression.

Table 8 includes detailed stream compositions for each of the streams contained in FIG. 5. In this design, the Joule-Thompson (JT) effect was used to provide the required cooling duty in the system and to increase CO₂ recovery from the vent gas. This design used relatively little external cooling and did not require any specialized equipment (e.g., membrane separators). The cooling of the inlet gas stream and the cooling of the condenser was provided by a combination of the reboiler duty of the distillation column and the evaporation of the depressurized bottoms from the column The distillate vapor stream leaving the column included about 60% CO₂; therefore CO₂ recovery was enhanced by the partial condensation of the vapor distillate, with the required cooling provided primarily by depressurizing the liquid condensate. After being depressurized and vaporized, this stream was compressed to the distillation column pressure and cooled before being fed back to the appropriate stage.

Dried CO₂ stream 1 was first cooled to −6° C. by heat exchange with evaporating fluid in the reboiler (M1) before further cooling to about −23° C. by the cold box (M2) and supplemental refrigeration (M7). Cooling in the cold box was provided by the evaporation of depressurized high purity (99.99%) CO₂ streams 7 and 12 at 14 bar (−31° C.) and 21.3 bar (−18° C.), respectively. Bottoms stream 6 was used to provide the required evaporative cooling in the condenser (M4). More CO₂ was recovered from the vapor distillate stream 17 by partially condensing it in the cold box (M5) to yield a two-phase stream 18. Two-phase stream 18 was then separated in the flash drum (M6). The low temperature vapor stream 24 (−42° C.) and the throttled stream 20 (−50° C., 12.2 bar) provided the requisite cooling in M5. The 96% pure CO₂ stream 21 was first compressed then cooled and fed back into the distillation column. The cooling duty was provided by the low temperature streams 25, 9 and 13a. Stream 10 was then compressed up to 21.3 bar to match the pressure of stream 13b, and the two streams were combined, compressed to 75 bar (safely in the supercritical state) and then pumped up to a pipeline pressure of 110 bar, making it suitable for sequestration.

TABLE 8
Stream compositions for the streams contained in FIG. 5 and described in Example 2.

| STREAM LABEL | 1 | 2 | 3 | 4 | 5 | 6 |
|---|---|---|---|---|---|---|
| Substream: MIXED | | | | | | |
| Mole Flow kmol/sec | | | | | | |
| NO | 1.24E−05 | 1.24E−05 | 1.24E−05 | 1.24E−05 | 2.77E−09 | 1.72E−09 |
| NO2 | 4.86E−06 | 4.86E−06 | 4.86E−06 | 4.86E−06 | 4.86E−06 | 3.01E−06 |
| N2O4 | 1.91E−09 | 1.91E−09 | 1.91E−09 | 1.91E−09 | 1.91E−09 | 1.18E−09 |
| N2 | 0.03072 | 0.03072 | 0.03072 | 0.03072 | 3.66E−07 | 2.27E−07 |
| O2 | 0.114001 | 0.114001 | 0.114001 | 0.114001 | 6.99E−06 | 4.34E−06 |
| CO2 | 1.775003 | 1.775003 | 1.775003 | 1.775003 | 1.606359 | 0.996782 |
| CO | 8.60E−04 | 8.60E−04 | 8.60E−04 | 8.60E−04 | 1.88E−08 | 1.17E−08 |
| AR | 0.095523 | 0.095523 | 0.095523 | 0.095523 | 4.23E−05 | 2.63E−05 |
| Mole Frac | | | | | | |
| NO | 6.15E−06 | 6.15E−06 | 6.15E−06 | 6.15E−06 | 1.73E−09 | 1.73E−09 |
| NO2 | 2.41E−06 | 2.41E−06 | 2.41E−06 | 2.41E−06 | 3.02E−06 | 3.02E−06 |
| N2O4 | 9.46E−10 | 9.46E−10 | 9.46E−10 | 9.46E−10 | 1.19E−09 | 1.19E−09 |
| N2 | 0.015237 | 0.015237 | 0.015237 | 0.015237 | 2.28E−07 | 2.28E−07 |
| O2 | 0.056544 | 0.056544 | 0.056544 | 0.056544 | 4.35E−06 | 4.35E−06 |
| CO2 | 0.880404 | 0.880404 | 0.880404 | 0.880404 | 0.999966 | 0.999966 |
| CO | 4.27E−04 | 4.27E−04 | 4.27E−04 | 4.27E−04 | 1.17E−08 | 1.17E−08 |
| AR | 0.04738 | 0.04738 | 0.04738 | 0.04738 | 2.64E−05 | 2.64E−05 |
| Mass Flow kg/sec | | | | | | |
| NO | 3.72E−04 | 3.72E−04 | 3.72E−04 | 3.72E−04 | 8.32E−08 | 5.16E−08 |
| NO2 | 2.23E−04 | 2.23E−04 | 2.23E−04 | 2.23E−04 | 2.23E−04 | 1.39E−04 |
| N2O4 | 1.75E−07 | 1.75E−07 | 1.75E−07 | 1.75E−07 | 1.75E−07 | 1.09E−07 |
| N2 | 0.860577 | 0.860577 | 0.860577 | 0.860577 | 1.03E−05 | 6.37E−06 |
| O2 | 3.647884 | 3.647884 | 3.647884 | 3.647884 | 2.24E−04 | 1.39E−04 |
| CO2 | 78.11754 | 78.11754 | 78.11754 | 78.11754 | 70.69553 | 43.86819 |
| CO | 0.024092 | 0.024092 | 0.024092 | 0.024092 | 5.27E−07 | 3.27E−07 |
| AR | 3.815958 | 3.815958 | 3.815958 | 3.815958 | 1.69E−03 | 1.05E−03 |
| Mass Frac | | | | | | |
| NO | 4.30E−06 | 4.30E−06 | 4.30E−06 | 4.30E−06 | 1.18E−09 | 1.18E−09 |
| NO2 | 2.58E−06 | 2.58E−06 | 2.58E−06 | 2.58E−06 | 3.16E−06 | 3.16E−06 |
| N2O4 | 2.03E−09 | 2.03E−09 | 2.03E−09 | 2.03E−09 | 2.48E−09 | 2.48E−09 |
| N2 | 9.95E−03 | 9.95E−03 | 9.95E−03 | 9.95E−03 | 1.45E−07 | 1.45E−07 |
| O2 | 0.042188 | 0.042188 | 0.042188 | 0.042188 | 3.16E−06 | 3.16E−06 |
| CO2 | 0.903441 | 0.903441 | 0.903441 | 0.903441 | 0.99997 | 0.99997 |
| CO | 2.79E−04 | 2.79E−04 | 2.79E−04 | 2.79E−04 | 7.45E−09 | 7.45E−09 |
| AR | 0.044132 | 0.044132 | 0.044132 | 0.044132 | 2.39E−05 | 2.39E−05 |
| SUMMARY PROPERTY DATA | | | | | | |
| Total Flow kmol/sec | 2.016125 | 2.016125 | 2.016125 | 2.016125 | 1.606413 | 0.996816 |
| Total Flow kg/sec | 86.46665 | 86.46665 | 86.46665 | 86.46665 | 70.69768 | 43.86952 |
| Total Flow cum/sec | 1.516121 | 1.230979 | 0.800299 | 0.451971 | 0.082068 | 0.237771 |
| Temperature C. | 27.35877 | −6.07781 | −15.745 | −23 | −8.5193 | −30.6344 |
| Pressure bar | 29 | 29 | 28.9 | 28.9 | 27.8 | 14 |
| Vapor Frac | 1 | 1 | 0.650548 | 0.327123 | 0 | 0.163849 |
| Liquid Frac | 0 | 0 | 0.349453 | 0.672877 | 1 | 0.836151 |
| Solid Frac | 0 | 0 | 0 | 0 | 0 | 0 |
| Enthalpy J/kmol | −3.48E+08 | −3.49E+08 | −3.54E+08 | −3.58E+08 | −4.08E+08 | −4.08E+08 |
| Enthalpy J/kg | −8.10E+06 | −8.14E+06 | −8.24E+06 | −8.34E+06 | −9.27E+06 | −9.27E+06 |
| Enthalpy kW | −7.01E+05 | −7.04E+05 | −7.13E+05 | −7.21E+05 | −6.55E+05 | −4.06E+05 |
| Entropy J/kmol-K | −23630.7 | −29072.5 | −46356.6 | −62998.1 | −76556.4 | −75889.4 |
| Entropy J/kg-K | −550.993 | −677.877 | −1080.89 | −1468.91 | −1739.54 | −1724.38 |
| Density kmol/cum | 1.329791 | 1.637822 | 2.519215 | 4.460744 | 19.5741 | 4.192344 |
| Density kg/cum | 57.0315 | 70.24218 | 108.043 | 191.3104 | 861.4491 | 184.5036 |
| Average MW | 42.88755 | 42.88755 | 42.88755 | 42.88755 | 44.00964 | 44.00964 |
| Liq Vol 60 F. cum/sec | 0.107979 | 0.107979 | 0.107979 | 0.107979 | 0.086036 | 0.053387 |
| *** ALL PHASES *** | | | | | | |
| Total Flow scfm | 1.01E+05 | 1.01E+05 | 1.01E+05 | 1.01E+05 | 80636.1 | 50036.54 |
| Temperature K | 300.5088 | 267.0722 | 257.405 | 250.15 | 264.6307 | 242.5156 |
| CPMX kJ/kg-K | 1.035382 | 1.136736 | 1.60178 | 1.895665 | 2.615782 | 1.939063 |
| STREAM LABEL | 7 | 9 | 10 | 11 | 12 | 13a |
| Substream: MIXED | | | | | | |
| Mole Flow kmol/sec | | | | | | |
| NO | 1.72E−09 | 1.72E−09 | 1.72E−09 | 1.72E−09 | 1.05E−09 | 1.05E−09 |
| NO2 | 3.01E−06 | 3.01E−06 | 3.01E−06 | 3.01E−06 | 1.84E−06 | 1.84E−06 |
| N2O4 | 1.18E−09 | 1.18E−09 | 1.18E−09 | 1.18E−09 | 7.24E−10 | 7.24E−10 |
| N2 | 2.27E−07 | 2.27E−07 | 2.27E−07 | 2.27E−07 | 1.39E−07 | 1.39E−07 |
| O2 | 4.34E−06 | 4.34E−06 | 4.34E−06 | 4.34E−06 | 2.65E−06 | 2.65E−06 |
| CO2 | 0.996782 | 0.996782 | 0.996782 | 0.996782 | 0.609577 | 0.609577 |
| CO | 1.17E−08 | 1.17E−08 | 1.17E−08 | 1.17E−08 | 7.14E−09 | 7.14E−09 |
| AR | 2.63E−05 | 2.63E−05 | 2.63E−05 | 2.63E−05 | 1.61E−05 | 1.61E−05 |
| Mole Frac | | | | | | |
| NO | 1.73E−09 | 1.73E−09 | 1.73E−09 | 1.73E−09 | 1.73E−09 | 1.73E−09 |
| NO2 | 3.02E−06 | 3.02E−06 | 3.02E−06 | 3.02E−06 | 3.02E−06 | 3.02E−06 |
| N2O4 | 1.19E−09 | 1.19E−09 | 1.19E−09 | 1.19E−09 | 1.19E−09 | 1.19E−09 |
| N2 | 2.28E−07 | 2.28E−07 | 2.28E−07 | 2.28E−07 | 2.28E−07 | 2.28E−07 |
| O2 | 4.35E−06 | 4.35E−06 | 4.35E−06 | 4.35E−06 | 4.35E−06 | 4.35E−06 |
| CO2 | 0.999966 | 0.999966 | 0.999966 | 0.999966 | 0.999966 | 0.999966 |
| CO | 1.17E−08 | 1.17E−08 | 1.17E−08 | 1.17E−08 | 1.17E−08 | 1.17E−08 |
| AR | 2.64E−05 | 2.64E−05 | 2.64E−05 | 2.64E−05 | 2.64E−05 | 2.64E−05 |
| Mass Flow kg/sec | | | | | | |
| NO | 5.16E−08 | 5.16E−08 | 5.16E−08 | 5.16E−08 | 3.16E−08 | 3.16E−08 |
| NO2 | 1.39E−04 | 1.39E−04 | 1.39E−04 | 1.39E−04 | 8.48E−05 | 8.48E−05 |
| N2O4 | 1.09E−07 | 1.09E−07 | 1.09E−07 | 1.09E−07 | 6.66E−08 | 6.66E−08 |
| N2 | 6.37E−06 | 6.37E−06 | 6.37E−06 | 6.37E−06 | 3.89E−06 | 3.89E−06 |
| O2 | 1.39E−04 | 1.39E−04 | 1.39E−04 | 1.39E−04 | 8.49E−05 | 8.49E−05 |
| CO2 | 43.86819 | 43.86819 | 43.86819 | 43.86819 | 26.82734 | 26.82734 |
| CO | 3.27E−07 | 3.27E−07 | 3.27E−07 | 3.27E−07 | 2.00E−07 | 2.00E−07 |
| AR | 1.05E−03 | 1.05E−03 | 1.05E−03 | 1.05E−03 | 6.42E−04 | 6.42E−04 |
| Mass Frac | | | | | | |
| NO | 1.18E−09 | 1.18E−09 | 1.18E−09 | 1.18E−09 | 1.18E−09 | 1.18E−09 |
| NO2 | 3.16E−06 | 3.16E−06 | 3.16E−06 | 3.16E−06 | 3.16E−06 | 3.16E−06 |
| N2O4 | 2.48E−09 | 2.48E−09 | 2.48E−09 | 2.48E−09 | 2.48E−09 | 2.48E−09 |
| N2 | 1.45E−07 | 1.45E−07 | 1.45E−07 | 1.45E−07 | 1.45E−07 | 1.45E−07 |
| O2 | 3.16E−06 | 3.16E−06 | 3.16E−06 | 3.16E−06 | 3.16E−06 | 3.16E−06 |
| CO2 | 0.99997 | 0.99997 | 0.99997 | 0.99997 | 0.99997 | 0.99997 |
| CO | 7.45E−09 | 7.45E−09 | 7.45E−09 | 7.45E−09 | 7.45E−09 | 7.45E−09 |
| AR | 2.39E−05 | 2.39E−05 | 2.39E−05 | 2.39E−05 | 2.39E−05 | 2.39E−05 |
| SUMMARY PROPERTY DATA | | | | | | |
| Total Flow kmol/sec | 0.996816 | 0.996816 | 0.996816 | 0.996816 | 0.609597 | 0.609597 |
| Total Flow kg/sec | 43.86952 | 43.86952 | 43.86952 | 43.86952 | 26.82816 | 26.82816 |
| Total Flow cum/sec | 1.104865 | 1.345796 | 1.651132 | 1.211411 | 0.064749 | 0.494664 |
| Temperature C. | −30.6296 | −15 | 27 | 62.57696 | −17.5843 | −15 |
| Pressure bar | 14 | 14 | 14 | 21.3 | 21.3 | 21.3 |
| Vapor Frac | 0.9 | 1 | 1 | 1 | 0.077673 | 1 |
| Liquid Frac | 0.1 | 0 | 0 | 0 | 0.922327 | 0 |
| Solid Frac | 0 | 0 | 0 | 0 | 0 | 0 |
| Enthalpy J/kmol | −3.98E+08 | −3.96E+08 | −3.94E+08 | −3.93E+08 | −4.08E+08 | −3.96E+08 |
| Enthalpy J/kg | −9.04E+06 | −8.99E+06 | −8.95E+06 | −8.93E+06 | −9.27E+06 | −9.00E+06 |
| Enthalpy kW | −3.96E+05 | −3.94E+05 | −3.93E+05 | −3.92E+05 | −2.49E+05 | −2.42E+05 |
| Entropy J/kmol-K | −34515 | −26282.2 | −20062.4 | −19491.3 | −76366.4 | −31194.2 |
| Entropy J/kg-K | −784.259 | −597.191 | −455.865 | −442.887 | −1735.22 | −7.09E+02 |
| Density kmol/cum | 0.902207 | 0.740689 | 0.603717 | 0.822856 | 9.414835 | 1.23E+00 |
| Density kg/cum | 39.70579 | 32.59747 | 26.56936 | 36.21358 | 414.3435 | 5.42E+01 |
| Average MW | 44.00964 | 44.00964 | 44.00964 | 44.00964 | 44.00964 | 44.00964 |
| Liq Vol 60 F. cum/sec | 0.053387 | 0.053387 | 0.053387 | 0.053387 | 0.032649 | 0.032649 |
| *** ALL PHASES *** | | | | | | |
| Total Flow scfm | 50036.54 | 50036.54 | 50036.54 | 50036.54 | 30599.56 | 30599.56 |
| Temperature K | 242.5204 | 258.15 | 300.15 | 335.727 | 255.5657 | 258.15 |
| CPMX kJ/kg-K | 1.077785 | 0.942649 | 0.938888 | 0.987291 | 2.267516 | 1.083041 |
| STREAM LABEL | 13b | 14 | 15 | 16 | 17 | 18 |
| Substream: MIXED | | | | | | |
| Mole Flow kmol/sec | | | | | | |
| NO | 1.05E−09 | 2.77E−09 | 2.77E−09 | 2.77E−09 | 1.31E−05 | 1.31E−05 |
| NO2 | 1.84E−06 | 4.86E−06 | 4.86E−06 | 4.86E−06 | 1.44E−09 | 1.44E−09 |
| N2O4 | 7.24E−10 | 1.91E−09 | 1.91E−09 | 1.91E−09 | 5.60E−13 | 5.60E−13 |
| N2 | 1.39E−07 | 3.66E−07 | 3.66E−07 | 3.66E−07 | 0.03142 | 0.03142 |
| O2 | 2.65E−06 | 6.99E−06 | 6.99E−06 | 6.99E−06 | 0.117848 | 0.117848 |
| CO2 | 0.609577 | 1.606359 | 1.606359 | 1.606359 | 0.391939 | 0.391939 |
| CO | 7.14E−09 | 1.88E−08 | 1.88E−08 | 1.88E−08 | 8.83E−04 | 8.83E−04 |
| AR | 1.61E−05 | 4.23E−05 | 4.23E−05 | 4.23E−05 | 0.100523 | 0.100523 |
| Mole Frac | | | | | | |
| NO | 1.73E−09 | 1.73E−09 | 1.73E−09 | 1.73E−09 | 2.04E−05 | 2.04E−05 |
| NO2 | 3.02E−06 | 3.02E−06 | 3.02E−06 | 3.02E−06 | 2.24E−09 | 2.24E−09 |
| N2O4 | 1.19E−09 | 1.19E−09 | 1.19E−09 | 1.19E−09 | 8.71E−13 | 8.71E−13 |
| N2 | 2.28E−07 | 2.28E−07 | 2.28E−07 | 2.28E−07 | 0.048894 | 0.048894 |
| O2 | 4.35E−06 | 4.35E−06 | 4.35E−06 | 4.35E−06 | 0.183385 | 0.183385 |
| CO2 | 0.999966 | 0.999966 | 0.999966 | 0.999966 | 0.609902 | 0.609902 |
| CO | 1.17E−08 | 1.17E−08 | 1.17E−08 | 1.17E−08 | 1.37E−03 | 1.37E−03 |
| AR | 2.64E−05 | 2.64E−05 | 2.64E−05 | 2.64E−05 | 0.156425 | 0.156425 |
| Mass Flow kg/sec | | | | | | |
| NO | 3.16E−08 | 8.32E−08 | 8.32E−08 | 8.32E−08 | 3.94E−04 | 3.94E−04 |
| NO2 | 8.48E−05 | 2.23E−04 | 2.23E−04 | 2.23E−04 | 6.62E−08 | 6.62E−08 |
| N2O4 | 6.66E−08 | 1.75E−07 | 1.75E−07 | 1.75E−07 | 5.15E−11 | 5.15E−11 |
| N2 | 3.89E−06 | 1.03E−05 | 1.03E−05 | 1.03E−05 | 0.880197 | 0.880197 |
| O2 | 8.49E−05 | 2.24E−04 | 2.24E−04 | 2.24E−04 | 3.771008 | 3.771008 |
| CO2 | 26.82734 | 70.69553 | 70.69553 | 70.69553 | 17.24918 | 17.24918 |
| CO | 2.00E−07 | 5.27E−07 | 5.27E−07 | 5.27E−07 | 0.024723 | 0.024723 |
| AR | 6.42E−04 | 1.69E−03 | 1.69E−03 | 1.69E−03 | 4.015687 | 4.015687 |
| Mass Frac | | | | | | |
| NO | 1.18E−09 | 1.18E−09 | 1.18E−09 | 1.18E−09 | 1.52E−05 | 1.52E−05 |
| NO2 | 3.16E−06 | 3.16E−06 | 3.16E−06 | 3.16E−06 | 2.55E−09 | 2.55E−09 |
| N2O4 | 2.48E−09 | 2.48E−09 | 2.48E−09 | 2.48E−09 | 1.99E−12 | 1.99E−12 |
| N2 | 1.45E−07 | 1.45E−07 | 1.45E−07 | 1.45E−07 | 0.03393 | 0.03393 |
| O2 | 3.16E−06 | 3.16E−06 | 3.16E−06 | 3.16E−06 | 0.145368 | 0.145368 |
| CO2 | 0.99997 | 0.99997 | 0.99997 | 0.99997 | 0.664934 | 0.664934 |
| CO | 7.45E−09 | 7.45E−09 | 7.45E−09 | 7.45E−09 | 9.53E−04 | 9.53E−04 |
| AR | 2.39E−05 | 2.39E−05 | 2.39E−05 | 2.39E−05 | 0.1548 | 0.1548 |
| SUMMARY PROPERTY DATA | | | | | | |
| Total Flow kmol/sec | 0.609597 | 1.606413 | 1.606413 | 1.606413 | 0.642627 | 0.642627 |
| Total Flow kg/sec | 26.82816 | 70.69768 | 70.69768 | 70.69768 | 25.94118 | 25.94118 |
| Total Flow cum/sec | 0.635137 | 1.663595 | 0.112603 | 0.108943 | 0.398134 | 0.258753 |
| Temperature C. | 27 | 25.75864 | 25 | 32.94058 | −28.6347 | −41.4375 |
| Pressure bar | 21.3 | 21.3 | 75 | 110 | 27.5 | 27.5 |
| Vapor Frac | 1 | 1 | 0 | 0 | 1 | 0.635293 |
| Liquid Frac | 0 | 0 | 1 | 1 | 0 | 0.364707 |
| Solid Frac | 0 | 0 | 0 | 0 | 0 | 0 |
| Enthalpy J/kmol | −3.94E+08 | −3.94E+08 | −4.04E+08 | −4.03E+08 | −2.43E+08 | −2.48E+08 |
| Enthalpy J/kg | −8.96E+06 | −8.96E+06 | −9.17E+06 | −9.16E+06 | −6.02E+06 | −6.15E+06 |
| Enthalpy kW | −2.40E+05 | −6.34E+05 | −6.48E+05 | −6.48E+05 | −1.56E+05 | −1.59E+05 |
| Entropy J/kmol-K | −24360.5 | −24543.1 | −62531.4 | −62326.6 | −26286.8 | −47752.9 |
| Entropy J/kg-K | −5.54E+02 | −557.675 | −1420.86 | −1416.2 | −651.189 | −1182.96 |
| Density kmol/cum | 9.60E−01 | 0.965628 | 14.26623 | 14.74551 | 1.614096 | 2.483557 |
| Density kg/cum | 4.22E+01 | 42.49694 | 627.8518 | 648.9448 | 65.15686 | 100.2548 |
| Average MW | 44.00964 | 44.00964 | 44.00964 | 44.00964 | 40.36741 | 40.36741 |
| Liq Vol 60 F. cum/sec | 0.032649 | 0.086036 | 0.086036 | 0.086036 | 0.034418 | 0.034418 |
| *** ALL PHASES *** | | | | | | |
| Total Flow scfm | 30599.56 | 80636.1 | 80636.1 | 80636.1 | 32257.53 | 32257.53 |
| Temperature K | 300.15 | 298.9086 | 298.15 | 306.0906 | 244.5153 | 231.7125 |
| CPMX kJ/kg-K | 1.000246 | 1.001058 | 4.905458 | 3.45131 | 1.023441 | 1.372247 |
| STREAM LABEL | 19 | 20 | 21 | 22 | 23 | 24 |
| Substream: MIXED | | | | | | |
| Mole Flow kmol/sec | | | | | | |
| NO | 7.26E−07 | 7.26E−07 | 7.26E−07 | 7.26E−07 | 7.26E−07 | 1.24E−05 |
| NO2 | 1.43E−09 | 1.43E−09 | 1.43E−09 | 1.43E−09 | 1.43E−09 | 1.27E−11 |
| N2O4 | 5.55E−13 | 5.55E−13 | 5.55E−13 | 5.55E−13 | 5.55E−13 | 4.92E−15 |
| N2 | 7.01E−04 | 7.01E−04 | 7.01E−04 | 7.01E−04 | 7.01E−04 | 0.03072 |
| O2 | 3.85E−03 | 3.85E−03 | 3.85E−03 | 3.85E−03 | 3.85E−03 | 0.113994 |
| CO2 | 0.223294 | 0.223294 | 0.223294 | 0.223294 | 0.223294 | 0.168646 |
| CO | 2.26E−05 | 2.26E−05 | 2.26E−05 | 2.26E−05 | 2.26E−05 | 8.60E−04 |
| AR | 5.04E−03 | 5.04E−03 | 5.04E−03 | 5.04E−03 | 5.04E−03 | 0.095481 |
| Mole Frac | | | | | | |
| NO | 3.12E−06 | 3.12E−06 | 3.12E−06 | 3.12E−06 | 3.12E−06 | 3.02E−05 |
| NO2 | 6.12E−09 | 6.12E−09 | 6.12E−09 | 6.12E−09 | 6.12E−09 | 3.11E−11 |
| N2O4 | 2.38E−12 | 2.38E−12 | 2.38E−12 | 2.38E−12 | 2.38E−12 | 1.20E−14 |
| N2 | 3.01E−03 | 3.01E−03 | 3.01E−03 | 3.01E−03 | 3.01E−03 | 0.074979 |
| O2 | 0.016549 | 0.016549 | 0.016549 | 0.016549 | 0.016549 | 0.278228 |
| CO2 | 0.958697 | 0.958697 | 0.958697 | 0.958697 | 0.958697 | 0.41162 |
| CO | 9.69E−05 | 9.69E−05 | 9.69E−05 | 9.69E−05 | 9.69E−05 | 2.10E−03 |
| AR | 0.021646 | 0.021646 | 0.021646 | 0.021646 | 0.021646 | 0.233044 |
| Mass Flow kg/sec | | | | | | |
| NO | 2.18E−05 | 2.18E−05 | 2.18E−05 | 2.18E−05 | 2.18E−05 | 3.72E−04 |
| NO2 | 6.56E−08 | 6.56E−08 | 6.56E−08 | 6.56E−08 | 6.56E−08 | 5.86E−10 |
| N2O4 | 5.11E−11 | 5.11E−11 | 5.11E−11 | 5.11E−11 | 5.11E−11 | 4.53E−13 |
| N2 | 0.019627 | 0.019627 | 0.019627 | 0.019627 | 0.019627 | 0.86057 |
| O2 | 0.123341 | 0.123341 | 0.123341 | 0.123341 | 0.123341 | 3.647667 |
| CO2 | 9.8271 | 9.8271 | 9.8271 | 9.8271 | 9.8271 | 7.422076 |
| CO | 6.32E−04 | 6.32E−04 | 6.32E−04 | 6.32E−04 | 6.32E−04 | 0.024091 |
| AR | 0.201406 | 0.201406 | 0.201406 | 0.201406 | 0.201406 | 3.814281 |
| Mass Frac | | | | | | |
| NO | 2.14E−06 | 2.14E−06 | 2.14E−06 | 2.14E−06 | 2.14E−06 | 2.36E−05 |
| NO2 | 6.45E−09 | 6.45E−09 | 6.45E−09 | 6.45E−09 | 6.45E−09 | 3.72E−11 |
| N2O4 | 5.02E−12 | 5.02E−12 | 5.02E−12 | 5.02E−12 | 5.02E−12 | 2.87E−14 |
| N2 | 1.93E−03 | 1.93E−03 | 1.93E−03 | 1.93E−03 | 1.93E−03 | 0.054573 |
| O2 | 0.012125 | 0.012125 | 0.012125 | 0.012125 | 0.012125 | 0.231318 |
| CO2 | 0.966081 | 0.966081 | 0.966081 | 0.966081 | 0.966081 | 0.470673 |
| CO | 6.22E−05 | 6.22E−05 | 6.22E−05 | 6.22E−05 | 6.22E−05 | 1.53E−03 |
| AR | 0.0198 | 0.0198 | 0.0198 | 0.0198 | 0.0198 | 0.241884 |
| SUMMARY PROPERTY DATA | | | | | | |
| Total Flow kmol/sec | 0.232914 | 0.232914 | 0.232914 | 0.232914 | 0.232914 | 0.409713 |
| Total Flow kg/sec | 10.17213 | 10.17213 | 10.17213 | 10.17213 | 10.17213 | 15.76906 |
| Total Flow cum/sec | 1.00E−02 | 0.032303 | 0.322909 | 0.174183 | 0.047388 | 0.259058 |
| Temperature C. | −42.2074 | −49.6286 | −36.011 | 22.61584 | −14 | −42.2074 |
| Pressure bar | 26.5 | 12.19381 | 12.19381 | 28 | 28 | 26.5 |
| Vapor Frac | 0 | 0.072204 | 0.983717 | 1 | 0.279518 | 1 |
| Liquid Frac | 1 | 0.927797 | 0.016283 | 0 | 0.720482 | 0 |
| Solid Frac | 0 | 0 | 0 | 0 | 0 | 0 |
| Enthalpy J/kmol | −3.94E+08 | −3.94E+08 | −3.80E+08 | −3.79E+08 | −3.89E+08 | −1.65E+08 |
| Enthalpy J/kg | −9.03E+06 | −9.03E+06 | −8.71E+06 | −8.67E+06 | −8.90E+06 | −4.29E+06 |
| Enthalpy kW | −91806.5 | −91806.5 | −88602.5 | −88176.5 | −90527 | −67623.9 |
| Entropy J/kmol-K | −86514.4 | −86045 | −27389.2 | −26347.2 | −64537 | −25439.4 |
| Entropy J/kg-K | −1980.94 | −1970.19 | −627.137 | −603.278 | −1477.72 | −660.968 |
| Density kmol/cum | 23.27817 | 7.210239 | 0.721297 | 1.337176 | 4.915019 | 1.581551 |
| Density kg/cum | 1016.637 | 314.8956 | 31.50149 | 58.39899 | 214.6555 | 60.87077 |
| Average MW | 43.67339 | 43.67339 | 43.67339 | 43.67339 | 43.67339 | 38.48803 |
| Liq Vol 60 F. cum/sec | 0.012474 | 0.012474 | 0.012474 | 0.012474 | 0.012474 | 0.021943 |
| *** ALL PHASES *** | | | | | | |
| Total Flow scfm | 11691.41 | 11691.41 | 11691.41 | 11691.41 | 11691.41 | 20566.11 |
| Temperature K | 230.9426 | 223.5214 | 237.139 | 295.7658 | 259.15 | 230.9426 |
| CPMX kJ/kg-K | 1.997923 | 1.848244 | 0.938377 | 1.06216 | 2.102436 | 0.950465 |

| STREAM LABEL | 25 |
|---|---|
| Substream: MIXED | |
| Mole Flow kmol/sec | |
| NO | 1.24E−05 |
| NO2 | 1.27E−11 |
| N2O4 | 4.92E−15 |
| N2 | 0.03072 |
| O2 | 0.113994 |
| CO2 | 0.168646 |
| CO | 8.60E−04 |
| AR | 0.095481 |
| Mole Frac | |
| NO | 3.02E−05 |
| NO2 | 3.11E−11 |
| N2O4 | 1.20E−14 |
| N2 | 0.074979 |
| O2 | 0.278228 |
| CO2 | 0.41162 |
| CO | 2.10E−03 |
| AR | 0.233044 |
| Mass Flow kg/sec | |
| NO | 3.72E−04 |
| NO2 | 5.86E−10 |
| N2O4 | 4.53E−13 |
| N2 | 0.86057 |
| O2 | 3.647667 |
| CO2 | 7.422076 |
| CO | 0.024091 |
| AR | 3.814281 |
| Mass Frac | |
| NO | 2.36E−05 |
| NO2 | 3.72E−11 |
| N2O4 | 2.87E−14 |
| N2 | 0.054573 |
| O2 | 0.231318 |
| CO2 | 0.470673 |
| CO | 1.53E−03 |
| AR | 0.241884 |
| SUMMARY PROPERTY DATA | |
| Total Flow kmol/sec | 0.409713 |
| Total Flow kg/sec | 15.76906 |
| Total Flow cum/sec | 0.269702 |
| Temperature C. | −36.011 |
| Pressure bar | 26.5 |
| Vapor Frac | 1 |
| Liquid Frac | 0 |
| Solid Frac | 0 |
| Enthalpy J/kmol | −1.65E+08 |
| Enthalpy J/kg | −4.28E+06 |
| Enthalpy kW | −67531.7 |
| Entropy J/kmol-K | −24477.7 |
| Entropy J/kg-K | −635.983 |
| Density kmol/cum | 1.519134 |
| Density kg/cum | 58.46846 |
| Average MW | 38.48803 |
| Liq Vol 60 F. cum/sec | 0.021943 |
| *** ALL PHASES *** | |
| Total Flow scfm | 20566.11 |
| Temperature K | 237.139 |
| CPMX kJ/kg-K | 0.937337 |

cpmx = specific heat capacity of mixture

### Example 3

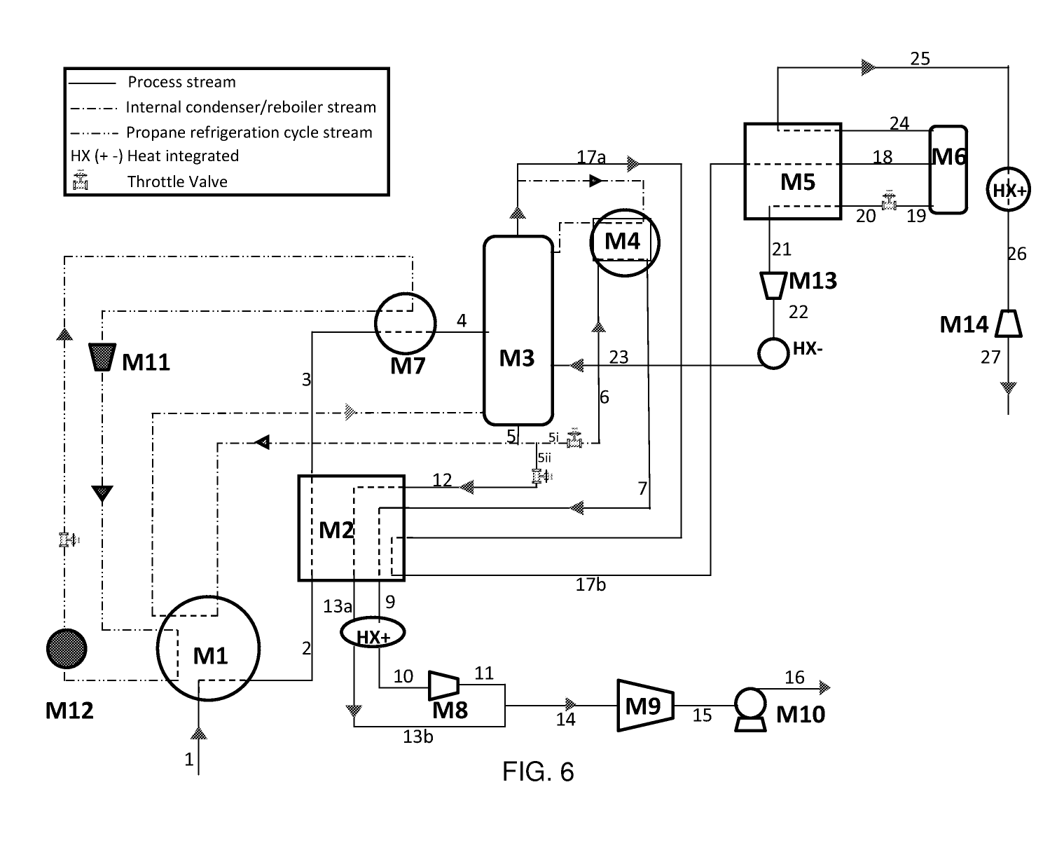

This example describes a simulation of an alternate arrangement (FIG. 6) of the system used to purify a carbon dioxide stream to remove non-condensable gases described in Example 2. In this simulation, additional cooling was provided to the inlet cold box (M2) using the low temperature vapor distillate stream 17a. This modification was aimed at reducing the required cooling load for the external refrigeration cycle. The stream data for this arrangement was similar to the stream data obtained in Example 1, with slight temperature and pressure differences in streams 17b and 26.

### Example 4

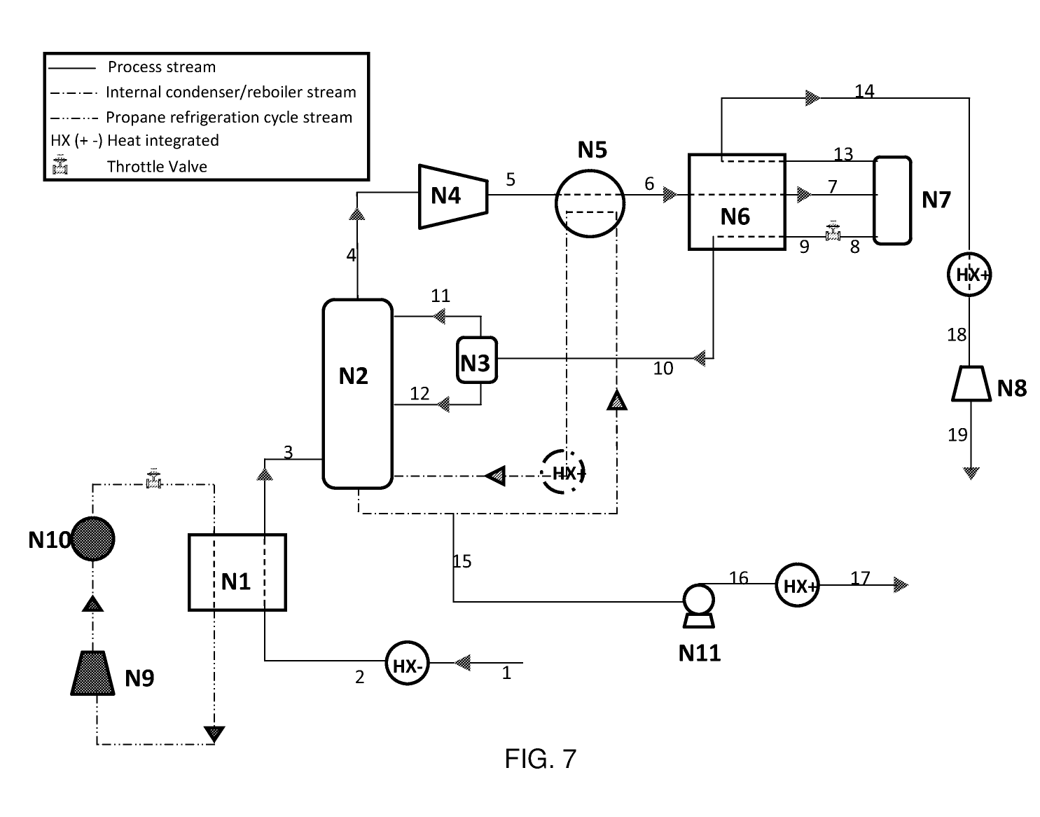

This examples describes a simulation of a second system used to purify a carbon dioxide stream to remove non-condensable gases. FIG. 7 includes a detailed schematic illustration of the process simulated in this example. In addition, Table 9 includes detailed stream compositions for each of the streams contained in FIG. 7.

This process also utilizes a distillation column for the purification of the CO₂ stream. One advantage of this system is that the purified CO₂ is extracted as bottoms liquid and pumped directly to sequestration, eliminating the energy penalty of gas phase compression of the purified stream. Previous systems designed to extract liquid CO₂ utilize large external refrigeration cycles for cooling the inlet gas and also for providing cooling duty to the condenser. This configuration was developed to replace the use of external refrigeration for providing cooling duty to the condenser and to lower the overall energy requirement by innovative use of internal heat integration. The cooling load for the condenser is now provided in part by the reboiler and in part by a joule-Thompson expansion of the distillate reflux distillate stream. Ordinarily, the condenser temperature is lower than that of the reboiler, making it impossible to integrate the two units. To overcome this limitation, the distillate vapor is compressed to a pressure high enough to ensure that condensation will take place at a higher temperature than the evaporation in the reboiler. The balance cooling is then provided by the Joule-Thompson effect. The two phase reflux stream is separated and fed into appropriate stages in the distillation column.

In the simulation outlined in FIG. 7, dry CO₂ stream entering at 29 bar and 27° C. was first pre-cooled to 0° C. by heat exchange with the exiting vent stream 14 (−10° C.). Optionally, the dry CO₂ stream can also be pre-cooled by the sequestration CO₂ streams 16 at 1° C. and subsequently by heat exchange with evaporating reboiler fluid. The cool inlet stream next entered the cold box (N1) where it was further cooled to about −31° C. by an external propane refrigeration cycle. The two-phase stream 3 was fed into an appropriate stage in the distillation column (determined by the stage composition) where separation resulted from the interaction between the down-coming liquid and the up-rising vapor stream. High purity (99.9%) CO₂ was extracted from the column bottoms at about −7° C. and 28.9 bar, and then pumped directly to pipeline pressure of 110 bar. To utilize reboiler duty in providing partial cooling in the condenser, the distillate vapor was first compressed (N4) to about 53 bar and then passed through the reboiler/condenser heat exchanger (N5) where the vapor fraction is dropped to about 0.83. The two-phase stream 6 then proceeded to the heat exchanger (N6) where further cooling condensed more of the CO₂, until a vapor fraction of about 0.36 was achieved. The flash drum (N7) was then used for phase separation and the resulting vent (13) and depressurized reflux (9) streams provided the cooling duty for the heat exchanger (N6). The two-phase, 90% CO₂ stream 10 at −10° C. and 31.6 bar was then recycled back to the distillation column However, the two phases were first separated (N3) and fed into appropriate stages of the distillation column (stage 2 for the liquid phase, and stage 3 for the gas phase).

TABLE 9
Stream compositions for the streams contained in FIG. 7 and described in Example 4.

| STREAM LABEL | 1 | 2 | 3 | 4 | 5 | 6 |
|---|---|---|---|---|---|---|
| Substream: MIXED | | | | | | |
| Mole Flow kmol/sec | | | | | | |
| NO | 1.23E−05 | 1.23E−05 | 1.23E−05 | 1.63E−05 | 1.63E−05 | 1.63E−05 |
| NO2 | 4.80E−06 | 4.80E−06 | 4.80E−06 | 7.95E−08 | 7.95E−08 | 7.95E−08 |
| N2O4 | 1.87E−09 | 1.87E−09 | 1.87E−09 | 3.09E−11 | 3.09E−11 | 3.09E−11 |
| N2 | 0.030719 | 0.030719 | 0.030719 | 0.036219 | 0.036219 | 0.036219 |
| O2 | 0.114257 | 0.114257 | 0.114257 | 0.14212 | 0.14212 | 0.14212 |
| CO2 | 1.775013 | 1.775013 | 1.775013 | 0.82426 | 0.82426 | 0.82426 |
| CO | 8.60E−04 | 8.60E−04 | 8.60E−04 | 1.03E−03 | 1.03E−03 | 1.03E−03 |
| AR | 0.095516 | 0.095516 | 0.095516 | 0.128112 | 0.128112 | 0.128112 |
| Mole Frac | | | | | | |
| NO | 6.08E−06 | 6.08E−06 | 6.08E−06 | 1.44E−05 | 1.44E−05 | 1.44E−05 |
| NO2 | 2.38E−06 | 2.38E−06 | 2.38E−06 | 7.03E−08 | 7.03E−08 | 7.03E−08 |
| N2O4 | 9.28E−10 | 9.28E−10 | 9.28E−10 | 2.73E−11 | 2.73E−11 | 2.73E−11 |
| N2 | 0.015235 | 0.015235 | 0.015235 | 0.032003 | 0.032003 | 0.032003 |
| O2 | 0.056664 | 0.056664 | 0.056664 | 0.125574 | 0.125574 | 0.125574 |
| CO2 | 0.880296 | 0.880296 | 0.880296 | 0.7283 | 0.7283 | 0.7283 |
| CO | 4.27E−04 | 4.27E−04 | 4.27E−04 | 9.12E−04 | 9.12E−04 | 9.12E−04 |
| AR | 0.04737 | 0.04737 | 0.04737 | 0.113197 | 0.113197 | 0.113197 |
| Mass Flow kg/sec | | | | | | |
| NO | 3.68E−04 | 3.68E−04 | 3.68E−04 | 4.89E−04 | 4.89E−04 | 4.89E−04 |
| NO2 | 2.21E−04 | 2.21E−04 | 2.21E−04 | 3.66E−06 | 3.66E−06 | 3.66E−06 |
| N2O4 | 1.72E−07 | 1.72E−07 | 1.72E−07 | 2.84E−09 | 2.84E−09 | 2.84E−09 |
| N2 | 0.860548 | 0.860548 | 0.860548 | 1.014624 | 1.014624 | 1.014624 |
| O2 | 3.656082 | 3.656082 | 3.656082 | 4.547656 | 4.547656 | 4.547658 |
| CO2 | 78.11798 | 78.11798 | 78.11798 | 36.2755 | 36.2755 | 36.27551 |
| CO | 0.024094 | 0.024094 | 0.024094 | 0.028897 | 0.028897 | 0.028898 |
| AR | 3.81568 | 3.81568 | 3.81568 | 5.117799 | 5.117799 | 5.117799 |
| Mass Frac | | | | | | |
| NO | 4.25E−06 | 4.25E−06 | 4.25E−06 | 1.04E−05 | 1.04E−05 | 1.04E−05 |
| NO2 | 2.55E−06 | 2.55E−06 | 2.55E−06 | 7.79E−08 | 7.79E−08 | 7.79E−08 |
| N2O4 | 1.99E−09 | 1.99E−09 | 1.99E−09 | 6.05E−11 | 6.05E−11 | 6.05E−11 |
| N2 | 9.95E−03 | 9.95E−03 | 9.95E−03 | 0.021595 | 0.021595 | 0.021595 |
| O2 | 0.042279 | 0.042279 | 0.042279 | 0.09679 | 0.09679 | 0.09679 |
| CO2 | 0.903359 | 0.903359 | 0.903359 | 0.772066 | 0.772066 | 0.772066 |
| CO | 2.79E−04 | 2.79E−04 | 2.79E−04 | 6.15E−04 | 6.15E−04 | 6.15E−04 |
| AR | 0.044125 | 0.044125 | 0.044125 | 0.108924 | 0.108924 | 0.108924 |
| SUMMARY PROPERTY DATA | | | | | | |
| Total Flow kmol/sec | 2.016383 | 2.016383 | 2.016383 | 1.131758 | 1.131758 | 1.131758 |
| Total Flow kg/sec | 86.47497 | 86.47497 | 86.47497 | 46.98497 | 46.98497 | 46.98499 |
| Total Flow cum/sec | 1.515772 | 1.287021 | 0.311969 | 0.674821 | 0.460906 | 0.29178 |
| Temperature C. | 27.28491 | 0 | −31 | −21.1115 | 38.26611 | −5 |
| Pressure bar | 29 | 29 | 29 | 28.5 | 53.5 | 53.5 |
| Vapor Frac | 1 | 1 | 0.202737 | 1 | 1 | 0.835707 |
| Liquid Frac | 0 | 0 | 0.797263 | 0 | 0 | 0.164293 |
| Solid Frac | 0 | 0 | 0 | 0 | 0 | 0 |
| Enthalpy J/kmol | −3.47E+08 | −3.49E+08 | −3.60E+08 | −2.90E+08 | −2.88E+08 | −2.92E+08 |
| Enthalpy J/kg | −8.10E+06 | −8.13E+06 | −8.39E+06 | −6.97E+06 | −6.93E+06 | −7.02E+06 |
| Enthalpy kW | −7.01E+05 | −7.03E+05 | −7.25E+05 | −3.28E+05 | −3.26E+05 | −3.30E+05 |
| Entropy J/kmol-K | −23639.2 | −27988 | −71288.6 | −27721.3 | −26044.8 | −39250.3 |
| Entropy J/kg-K | −551.207 | −652.612 | −1662.27 | −667.742 | −627.358 | −945.447 |
| Density kmol/cum | 1.330268 | 1.566705 | 6.463413 | 1.677124 | 2.455506 | 3.878801 |
| Density kg/cum | 57.05012 | 67.19001 | 277.1912 | 69.62586 | 101.9404 | 161.0286 |
| Average MW | 42.88619 | 42.88619 | 42.88619 | 41.51504 | 41.51504 | 41.51504 |
| Liq Vol 60 F. cum/sec | 0.107993 | 0.107993 | 0.107993 | 0.060614 | 0.060614 | 0.060614 |
| *** ALL PHASES *** | | | | | | |
| Total Flow scfm | 1.01E+05 | 1.01E+05 | 1.01E+05 | 56810.12 | 56810.12 | 56810.14 |
| Temperature K | 300.4349 | 273.15 | 242.15 | 252.0385 | 311.4161 | 268.15 |
| CPMX kJ/kg-K | 1.035469 | 1.106229 | 1.929876 | 1.085745 | 1.136008 | 1.726966 |
| STREAM LABEL | 7 | 8 | 9 | 10 | 11 | 12 |
| Substream: MIXED | | | | | | |
| Mole Flow kmol/sec | | | | | | |
| NO | 1.63E−05 | 4.06E−06 | 4.06E−06 | 4.06E−06 | 3.90E−06 | 1.65E−07 |
| NO2 | 7.95E−08 | 7.88E−08 | 7.88E−08 | 7.88E−08 | 8.47E−09 | 7.03E−08 |
| N2O4 | 3.09E−11 | 3.06E−11 | 3.06E−11 | 3.06E−11 | 3.28E−12 | 2.73E−11 |
| N2 | 0.036219 | 5.50E−03 | 5.50E−03 | 5.50E−03 | 5.36E−03 | 1.44E−04 |
| O2 | 0.14212 | 0.027873 | 0.027873 | 0.027873 | 0.026927 | 9.46E−04 |
| CO2 | 0.82426 | 0.658082 | 0.658082 | 0.658082 | 0.449965 | 0.208117 |
| CO | 1.03E−03 | 1.71E−04 | 1.71E−04 | 1.71E−04 | 1.67E−04 | 4.94E−06 |
| AR | 0.128112 | 0.032695 | 0.032695 | 0.032695 | 0.031174 | 1.52E−03 |
| Mole Frac | | | | | | |
| NO | 1.44E−05 | 5.61E−06 | 5.61E−06 | 5.61E−06 | 7.59E−06 | 7.84E−07 |
| NO2 | 7.03E−08 | 1.09E−07 | 1.09E−07 | 1.09E−07 | 1.65E−08 | 3.34E−07 |
| N2O4 | 2.73E−11 | 4.22E−11 | 4.22E−11 | 4.22E−11 | 6.38E−12 | 1.30E−10 |
| N2 | 0.032003 | 7.59E−03 | 7.59E−03 | 7.59E−03 | 0.01043 | 6.82E−04 |
| O2 | 0.125574 | 0.038481 | 0.038481 | 0.038481 | 0.052429 | 4.49E−03 |
| CO2 | 0.7283 | 0.908544 | 0.908544 | 0.908544 | 0.876112 | 0.987588 |
| CO | 9.12E−04 | 2.37E−04 | 2.37E−04 | 2.37E−04 | 3.24E−04 | 2.34E−05 |
| AR | 0.113197 | 0.045139 | 0.045139 | 0.045139 | 0.060698 | 7.22E−03 |
| Mass Flow kg/sec | | | | | | |
| NO | 4.89E−04 | 1.22E−04 | 1.22E−04 | 1.22E−04 | 1.17E−04 | 4.96E−06 |
| NO2 | 3.66E−06 | 3.62E−06 | 3.62E−06 | 3.62E−06 | 3.90E−07 | 3.23E−06 |
| N2O4 | 2.84E−09 | 2.82E−09 | 2.82E−09 | 2.82E−09 | 3.02E−10 | 2.51E−09 |
| N2 | 1.014624 | 0.154084 | 0.154084 | 0.154084 | 0.150056 | 4.03E−03 |
| O2 | 4.547658 | 0.891891 | 0.891891 | 0.891891 | 0.861633 | 0.030258 |
| CO2 | 36.27551 | 28.96204 | 28.96204 | 28.96204 | 19.80286 | 9.159178 |
| CO | 0.028898 | 4.80E−03 | 4.80E−03 | 4.80E−03 | 4.67E−03 | 1.38E−04 |
| AR | 5.117799 | 1.306104 | 1.306104 | 1.306104 | 1.245339 | 0.060765 |
| Mass Frac | | | | | | |
| NO | 1.04E−05 | 3.89E−06 | 3.89E−06 | 3.89E−06 | 5.30E−06 | 5.36E−07 |
| NO2 | 7.79E−08 | 1.16E−07 | 1.16E−07 | 1.16E−07 | 1.77E−08 | 3.50E−07 |
| N2O4 | 6.05E−11 | 8.99E−11 | 8.99E−11 | 8.99E−11 | 1.37E−11 | 2.72E−10 |
| N2 | 0.021595 | 4.92E−03 | 4.92E−03 | 4.92E−03 | 6.80E−03 | 4.35E−04 |
| O2 | 0.09679 | 0.028478 | 0.028478 | 0.028478 | 0.03905 | 3.27E−03 |
| CO2 | 0.772066 | 0.924742 | 0.924742 | 0.924742 | 0.897492 | 0.989713 |
| CO | 6.15E−04 | 1.53E−04 | 1.53E−04 | 1.53E−04 | 2.11E−04 | 1.49E−05 |
| AR | 0.108924 | 0.041703 | 0.041703 | 0.041703 | 0.05644 | 6.57E−03 |
| SUMMARY PROPERTY DATA | | | | | | |
| Total Flow kmol/sec | 1.131758 | 0.724325 | 0.724325 | 0.724325 | 0.513593 | 0.210733 |
| Total Flow kg/sec | 46.98499 | 31.31905 | 31.31905 | 31.31905 | 22.06467 | 9.254376 |
| Total Flow cum/sec | 0.157373 | 0.033968 | 0.067562 | 0.281305 | 0.270617 | 0.010688 |
| Temperature C. | −26.871 | −26.871 | −32.779 | −10.2095 | −10.2095 | −10.2095 |
| Pressure bar | 53.5 | 53.5 | 31.5665 | 31.5665 | 31.5665 | 31.5665 |
| Vapor Frac | 0.36 | 0 | 0.098983 | 0.709064 | 1 | 0 |
| Liquid Frac | 0.64 | 1 | 0.901017 | 0.290936 | 0 | 1 |
| Solid Frac | 0 | 0 | 0 | 0 | 0 | 0 |
| Enthalpy J/kmol | −2.97E+08 | −3.72E+08 | −3.72E+08 | −3.64E+08 | −3.48E+08 | −4.03E+08 |
| Enthalpy J/kg | −7.16E+06 | −8.61E+06 | −8.61E+06 | −8.41E+06 | −8.09E+06 | −9.17E+06 |
| Enthalpy kW | −3.36E+05 | −2.70E+05 | −2.70E+05 | −2.63E+05 | −1.79E+05 | −84905.2 |
| Entropy J/kmol-K | −61196.4 | −77845.5 | −77258.9 | −44166.7 | −31003.7 | −76247.4 |
| Entropy J/kg-K | −1474.08 | −1800.36 | −1786.79 | −1021.46 | −721.664 | −1736.24 |
| Density kmol/cum | 7.191559 | 21.32361 | 10.72083 | 2.574879 | 1.897862 | 19.7165 |
| Density kg/cum | 298.5578 | 922.01 | 463.557 | 111.335 | 81.53483 | 865.8557 |
| Average MW | 41.51504 | 43.23892 | 43.23892 | 43.23892 | 42.96141 | 43.91528 |
| Liq Vol 60 F. cum/sec | 0.060614 | 0.038793 | 0.038793 | 0.038793 | 0.027507 | 0.011286 |
| *** ALL PHASES *** | | | | | | |
| Total Flow scfm | 56810.14 | 36358.49 | 36358.49 | 36358.49 | 25780.49 | 10578 |
| Temperature K | 246.279 | 246.279 | 240.371 | 262.9406 | 262.9406 | 262.9406 |
| CPMX kJ/kg-K | 1.894801 | 2.234203 | 2.015847 | 1.625677 | 1.22839 | 2.572905 |

| STREAM LABEL | 13 | 14 | 15 | 16 | 17 |
|---|---|---|---|---|---|
| Substream: MIXED | | | | | |
| Mole Flow kmol/sec | | | | | |
| NO | 1.22E−05 | 1.22E−05 | 4.80E−09 | 4.80E−09 | 4.80E−09 |
| NO2 | 7.51E−10 | 7.51E−10 | 4.80E−06 | 4.80E−06 | 4.80E−06 |
| N2O4 | 2.91E−13 | 2.91E−13 | 1.87E−09 | 1.87E−09 | 1.87E−09 |
| N2 | 0.030719 | 0.030719 | 3.28E−07 | 3.28E−07 | 3.28E−07 |
| O2 | 0.114247 | 0.114247 | 9.89E−06 | 9.89E−06 | 9.89E−06 |
| CO2 | 0.166178 | 0.166178 | 1.608835 | 1.608835 | 1.608835 |
| CO | 8.60E−04 | 8.60E−04 | 1.99E−08 | 1.99E−08 | 1.99E−08 |
| AR | 0.095416 | 0.095416 | 9.98E−05 | 9.98E−05 | 9.98E−05 |
| Mole Frac | | | | | |
| NO | 3.01E−05 | 3.01E−05 | 2.98E−09 | 2.98E−09 | 2.98E−09 |
| NO2 | 1.84E−09 | 1.84E−09 | 2.98E−06 | 2.98E−06 | 2.98E−06 |
| N2O4 | 7.13E−13 | 7.13E−13 | 1.16E−09 | 1.16E−09 | 1.16E−09 |
| N2 | 0.075396 | 0.075396 | 2.04E−07 | 2.04E−07 | 2.04E−07 |
| O2 | 0.280407 | 0.280407 | 6.15E−06 | 6.15E−06 | 6.15E−06 |
| CO2 | 0.407867 | 0.407867 | 0.999929 | 0.999929 | 0.999929 |
| CO | 2.11E−03 | 2.11E−03 | 1.24E−08 | 1.24E−08 | 1.24E−08 |
| AR | 0.234189 | 0.234189 | 6.20E−05 | 6.20E−05 | 6.20E−05 |
| Mass Flow kg/sec | | | | | |
| NO | 3.68E−04 | 3.68E−04 | 1.44E−07 | 1.44E−07 | 1.44E−07 |
| NO2 | 3.46E−08 | 3.46E−08 | 2.21E−04 | 2.21E−04 | 2.21E−04 |
| N2O4 | 2.67E−11 | 2.67E−11 | 1.72E−07 | 1.72E−07 | 1.72E−07 |
| N2 | 0.860539 | 0.860539 | 9.17E−06 | 9.17E−06 | 9.17E−06 |
| O2 | 3.655767 | 3.655767 | 3.16E−04 | 3.16E−04 | 3.16E−04 |
| CO2 | 7.313477 | 7.313477 | 70.80451 | 70.80451 | 70.80451 |
| CO | 0.024094 | 0.024094 | 5.57E−07 | 5.57E−07 | 5.57E−07 |
| AR | 3.811695 | 3.811695 | 3.99E−03 | 3.99E−03 | 3.99E−03 |
| Mass Frac | | | | | |
| NO | 2.35E−05 | 2.35E−05 | 2.03E−09 | 2.03E−09 | 2.03E−09 |
| NO2 | 2.21E−09 | 2.21E−09 | 3.12E−06 | 3.12E−06 | 3.12E−06 |
| N2O4 | 1.71E−12 | 1.71E−12 | 2.43E−09 | 2.43E−09 | 2.43E−09 |
| N2 | 0.054931 | 0.054931 | 1.30E−07 | 1.30E−07 | 1.30E−07 |
| O2 | 0.233358 | 0.233358 | 4.47E−06 | 4.47E−06 | 4.47E−06 |
| CO2 | 0.466839 | 0.466839 | 0.999936 | 0.999936 | 0.999936 |
| CO | 1.54E−03 | 1.54E−03 | 7.87E−09 | 7.87E−09 | 7.87E−09 |
| AR | 0.243311 | 0.243311 | 5.63E−05 | 5.63E−05 | 5.63E−05 |
| SUMMARY PROPERTY DATA | | | | | |
| Total Flow kmol/sec | 0.407433 | 0.407433 | 1.60895 | 1.60895 | 1.60895 |
| Total Flow kg/sec | 15.66594 | 15.66594 | 70.80905 | 70.80905 | 70.80905 |
| Total Flow cum/sec | 0.123405 | 0.140402 | 0.083028 | 0.080825 | 0.091612 |
| Temperature C. | −26.871 | −10.2095 | −7.13339 | 1.343376 | 18 |
| Pressure bar | 53.5 | 53.5 | 28.92 | 110 | 110 |
| Vapor Frac | 1 | 1 | 0 | 0 | 0 |
| Liquid Frac | 0 | 0 | 1 | 1 | 1 |
| Solid Frac | 0 | 0 | 0 | 0 | 0 |
| Enthalpy J/kmol | −1.64E+08 | −1.63E+08 | −4.08E+08 | −4.07E+08 | −4.05E+08 |
| Enthalpy J/kg | −4.26E+06 | −4.24E+06 | −9.26E+06 | −9.25E+06 | −9.21E+06 |
| Enthalpy kW | −66771.8 | −66471 | −6.56E+05 | −6.55E+05 | −6.52E+05 |
| Entropy J/kmol-K | −31598.1 | −28696.1 | −75992.3 | −75559.8 | −69092.9 |
| Entropy J/kg-K | −821.789 | −746.316 | −1726.73 | −1716.9 | −1569.96 |
| Density kmol/cum | 3.301594 | 2.901909 | 19.3785 | 19.90647 | 17.56264 |
| Density kg/cum | 126.9474 | 111.5794 | 852.8376 | 876.0732 | 772.9228 |
| Average MW | 38.45035 | 38.45035 | 44.00948 | 44.00948 | 44.00948 |
| Liq Vol 60 F. cum/sec | 0.021821 | 0.021821 | 0.086172 | 0.086172 | 0.086172 |
| *** ALL PHASES *** | | | | | |
| Total Flow scfm | 20451.65 | 20451.65 | 80763.42 | 80763.42 | 80763.42 |
| Temperature K | 246.279 | 262.9406 | 266.0166 | 274.4934 | 291.15 |
| CPMX kJ/kg-K | 1.216274 | 1.101763 | 2.663863 | 2.307363 | 2.73376 |

cpmx = specific heat capacity of mixture

### Example 5

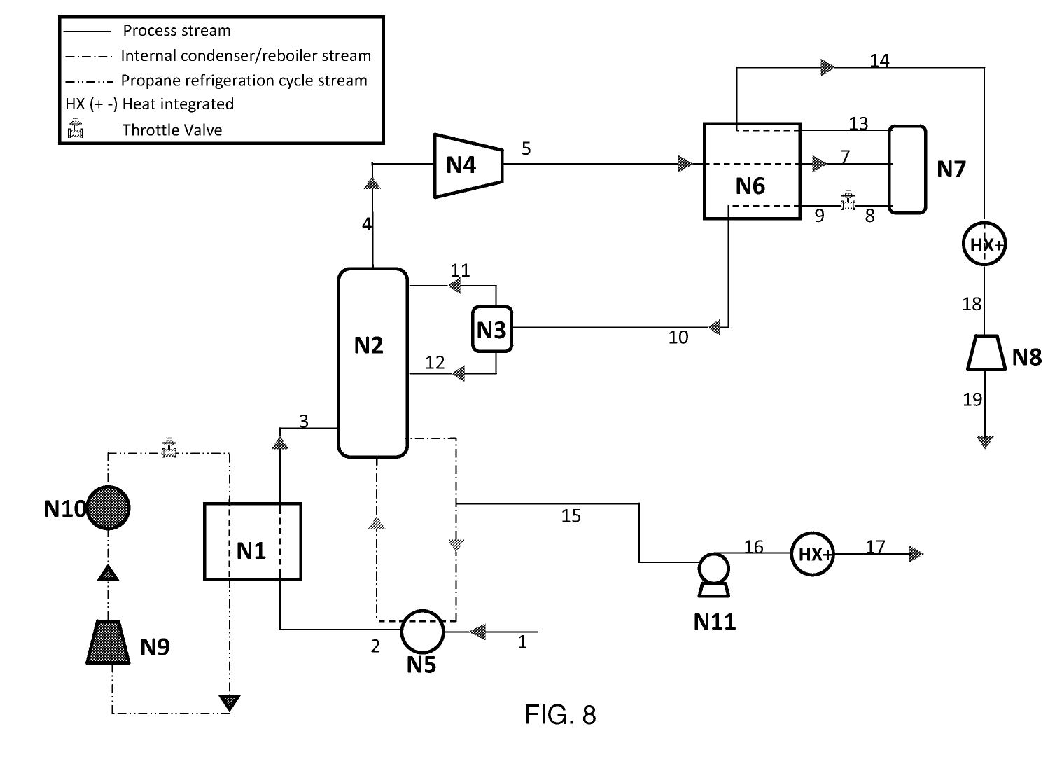

This example describes a simulation of a first alternate arrangement (FIG. 8) of the system used to purify a carbon dioxide stream to remove non-condensable gases described in Example 4. In this example, the first stage of the condenser where the cooling duty is provided by the reboiler has been removed. In this example, all the cooling is provided by Joule-Thompson cooling as implemented in the condenser second stage. In addition, in this example, the reboiler is used to provide some cooling for the inlet stream, thereby reducing the external refrigeration requirements.

### Example 6

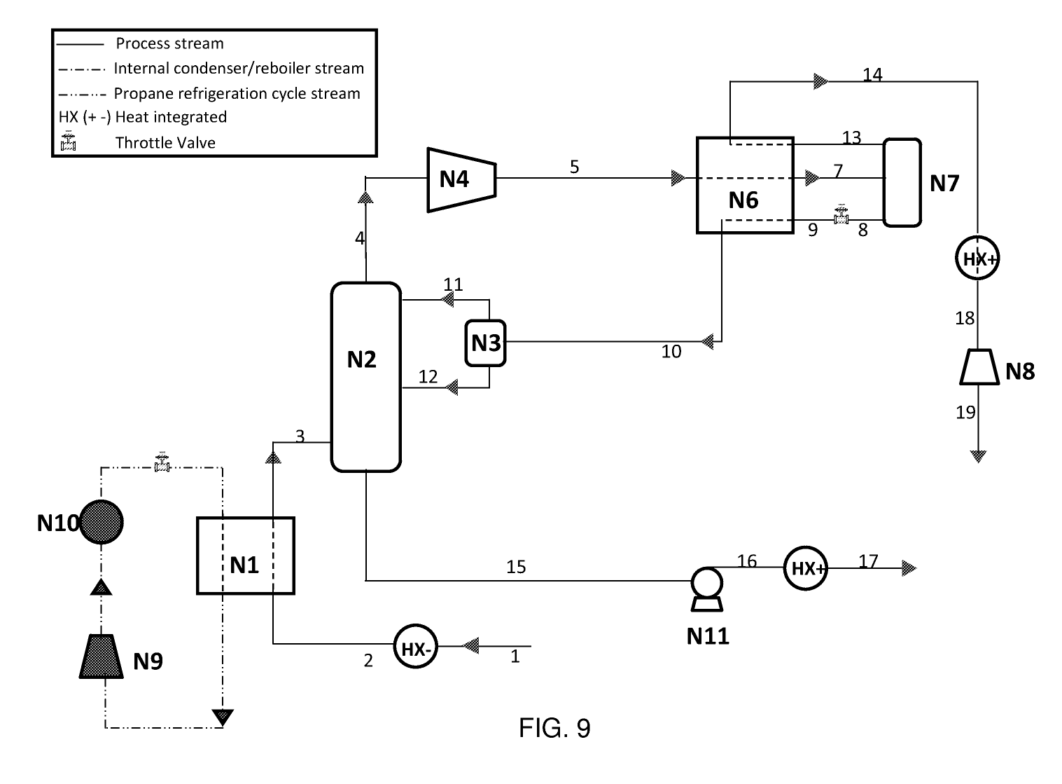

This example describes a simulation of a second alternate arrangement (FIG. 9) of the system described in Example 4. As in Example 5, the first stage of the condenser where the cooling duty is provided by the reboiler has been removed, and all the cooling provided by Joule-Thompson cooling is implemented in the condenser second stage. Unlike Example 5, however, the reboiler has been eliminated altogether.

### Example 7

This example describes simulations performed upon integrating the single-column NOₓ/SOₓ purifier outlined in Example 1 and various non-condensable gas purification schemes with the base power cycle described in Hong, J., et al., “Analysis of Oxy-Fuel Combustion Power Cycle Utilizing a Pressurized Coal Combustor,” Energy, 2009. Table 10 includes the results of simulating various integration options, using the base simulation described in Example 2 above. The “No Vent expansion” case describes a simulation in which the vent stream 26 was not expanded to recover power. The “Vent Gas Expansion” case describes a simulation where vent stream 26 was expanded to recover power. The “50% Vent Gas Recycle” case describes a simulation where the vent stream 26 (see FIG. 5) was split into two equal parts, and one of the parts was recycled to the combustor (because it contains oxygen) while the other part was expanded to recover power. The “O₂ recycle” case describes a simulation where the vent stream 26 was passed through a membrane separator where most of the oxygen was separated out from the rest of the stream. The oxygen-rich stream was recycled to the combustor while the rest of the stream was expanded to recover power.

TABLE 10
Major cycle power production/consumption breakdown
for various cycle integration options

| Cycle | | | | | | | | |
|---|---|---|---|---|---|---|---|---|
| power | | | | | | Ran- | | Effi- |
| breakdown | Units | ASU | CPU | Vent | FGR | kine | Net | ciency |
| No Vent | MW | 79.2 | 15.7 | 0 | 10.9 | 404.5 | 298.7 | 35.6 |
| Expansion | | | | | | | | |
| Vent gas | MW | 79.2 | 15.7 | 2.4 | 10.9 | 404.5 | 301.1 | 35.9 |
| Expansion | | | | | | | | |
| 50% Vent | MW | 77.3 | 18.0 | 2.0 | 10.9 | 404.1 | 300.0 | 35.8 |
| Gas Recycle | | | | | | | | |
| O₂ Recycle | MW | 75.3 | 15.7 | 1.7 | 10.9 | 404.2 | 304.0 | 36.2 |

FGR = flue gas recirculation work

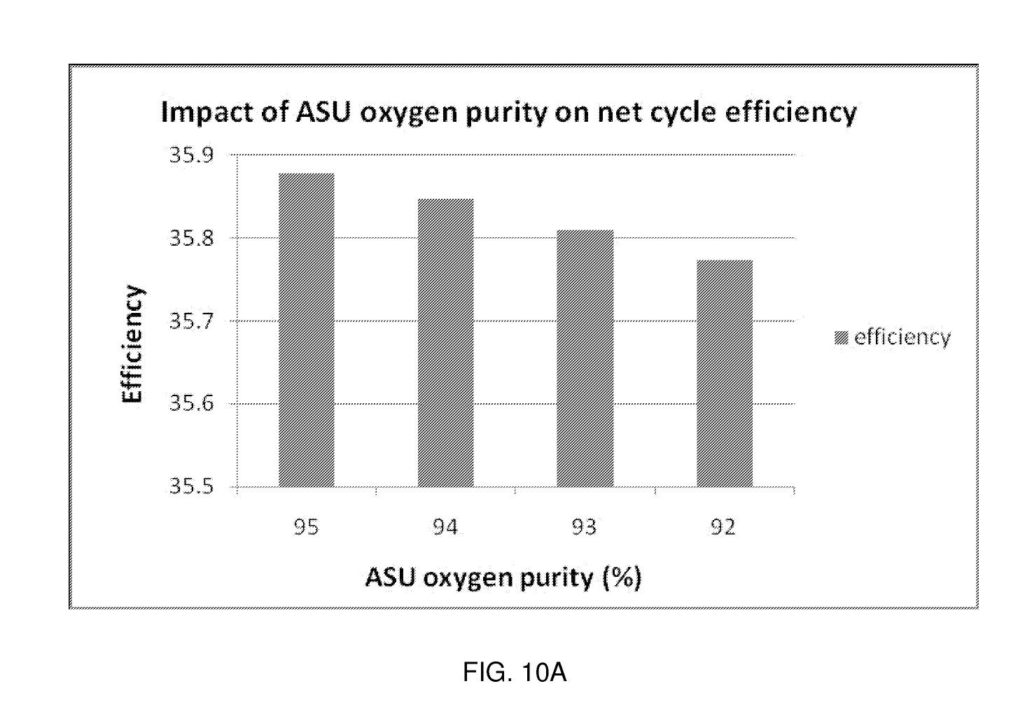

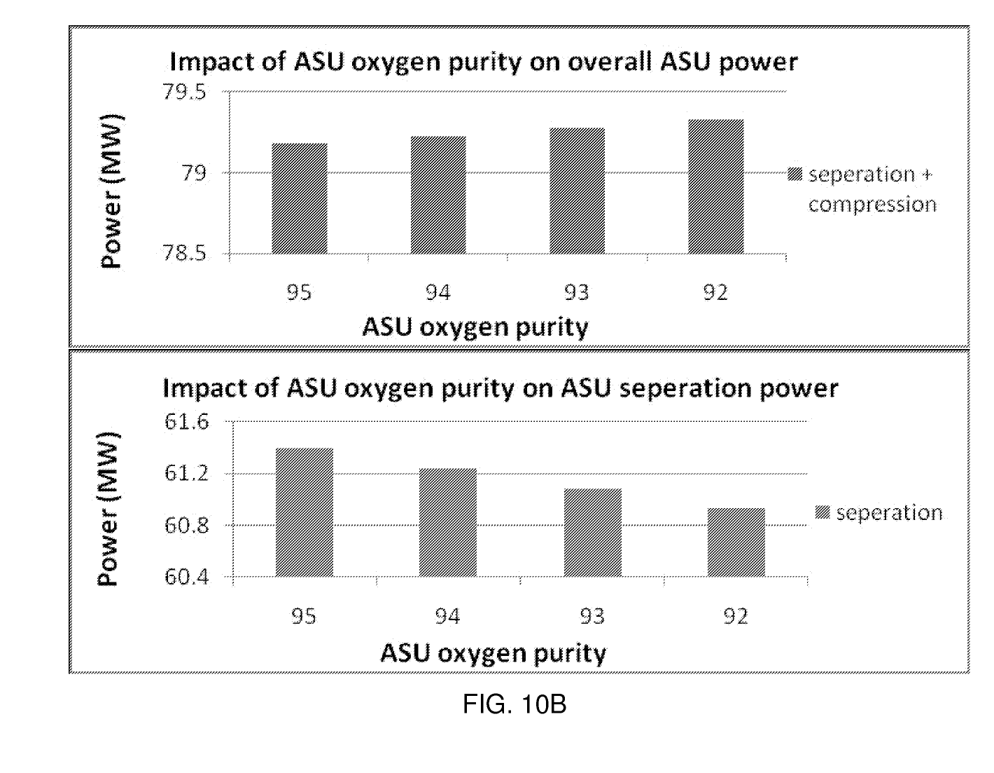

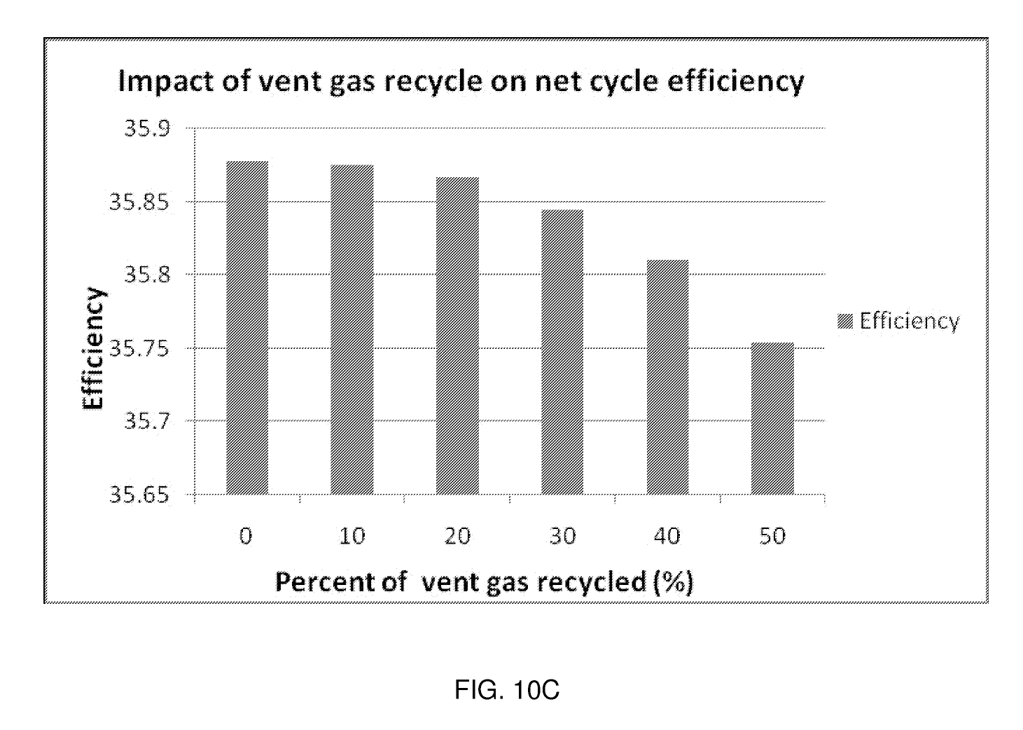

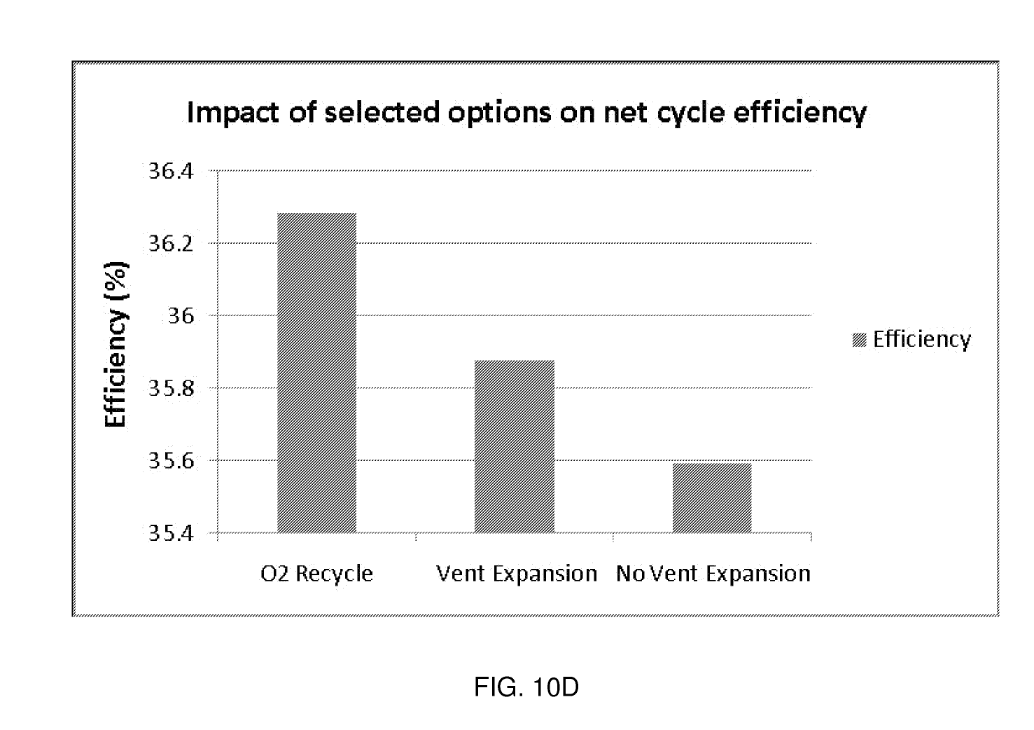

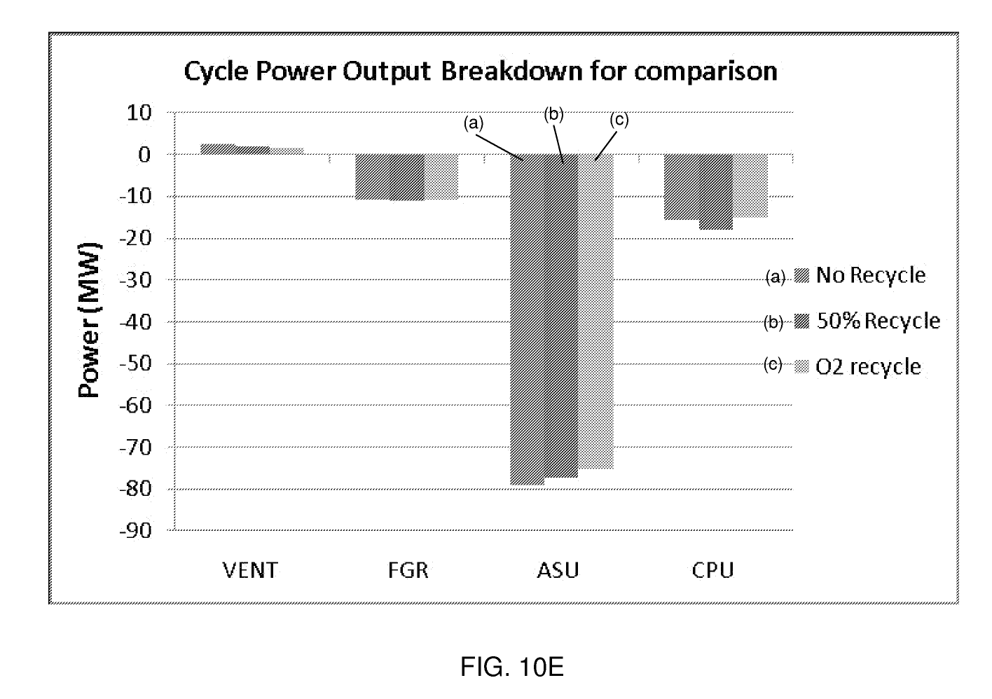

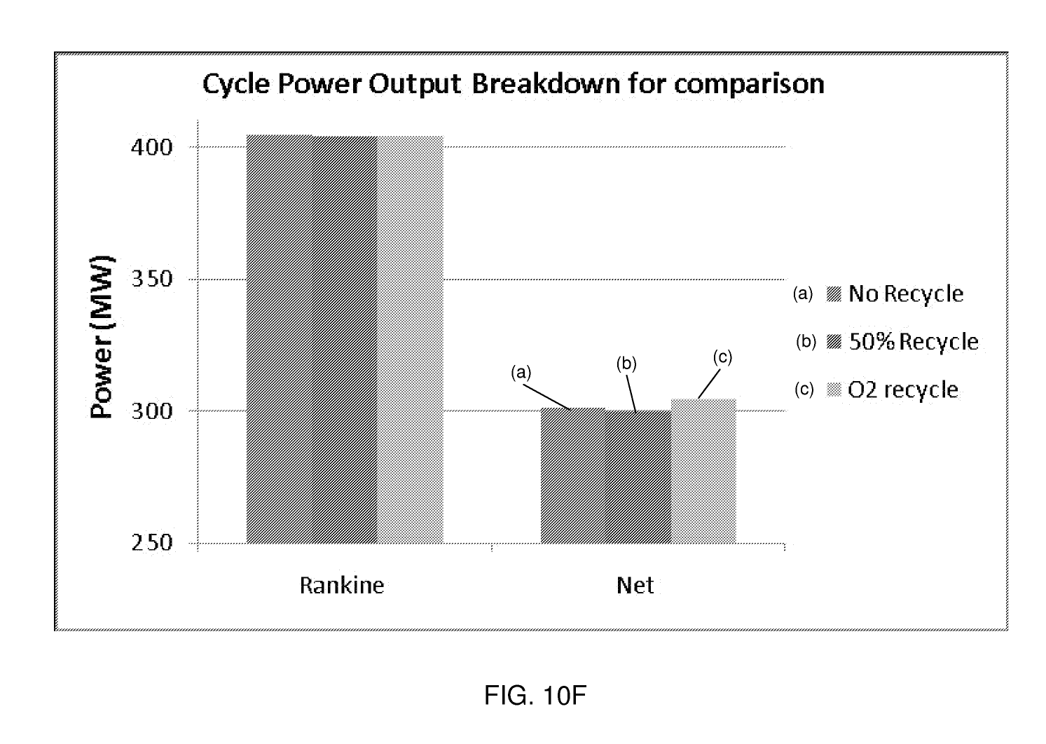

FIGS. 10A-10F include plots of the effects of various system parameters on the power and efficiency. FIG. 10A shows that reducing the purity requirement of the air separation unit does not lead to reductions in overall plant efficiency (a 0.1% drop in efficiency for an O₂ purity reduction from 95% to 92%) even though ASU power consumption was reduced (FIG. 10B). Total vent gas expansion resulted in a 0.3% increase in overall cycle efficiency. Vent gas recycle of up to 50% resulted in a decrease of about 0.1% in efficiency from the value obtained with total vent gas expansion (FIG. 10C). The power production/consumption breakdown of Table 10 shows that the decrease in cycle efficiency for vent recycle was due mainly to the increased power consumption of the CPU (FIG. 10E), even though ASU power was saved. Vent gas recycle requires more CPU power because when the flue gas stream contains higher impurity fractions, larger pressure drops are needed to provide the cooling load requirements of the purification system. The ASU power requirement is lower (see FIG. 10F) because oxygen is also recycled to the combustor, requiring less oxygen supply from the ASU. A better option is to utilize a membrane to separate out only the oxygen and recycle it to the combustor. This resulted in an increase in efficiency to over 36.2% (FIG. 10D).

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A method of purifying a carbon dioxide containing fluid inlet stream by removing NOₓ and SOₓ, comprising:
feeding the fluid inlet stream comprising carbon dioxide, NOₓ, and SOₓ to a single reactive absorption column; and
within the single reactive absorption column, removing at least a portion of the NOₓ and SOₓ to create a fluid outlet stream enriched in carbon dioxide and lean in SOₓ relative to the fluid inlet stream, and comprising less than about 50 ppm NOₓ.

2. A method of purifying a carbon dioxide containing fluid inlet stream by removing NOₓ and SOₓ, comprising:
feeding the fluid inlet stream comprising carbon dioxide, NOₓ, and SOₓ to a single reactive absorption column operated at a pressure of between about 20 bar and about 50 bar; and
within the single reactive absorption column, removing at least a portion of the NOₓ and SOₓ to create a fluid outlet stream enriched in carbon dioxide, lean in SOₓ, and lean in NOₓ relative to the fluid inlet stream.

3. A method of purifying a carbon dioxide containing fluid inlet stream by removing NOₓ and SOₓ, comprising:
feeding the fluid inlet stream comprising carbon dioxide, NOₓ, and SOₓ to a single reactive absorption column; and
within the single reactive absorption column, removing at least a portion of the NOₓ and SOₓ to create a fluid outlet stream enriched in carbon dioxide, lean in SOₓ, and lean in NOₓ relative to the fluid inlet stream,
wherein the removal step comprises feeding an acid condensate stream to the absorption column, the acid condensate stream originating from a condenser unit upstream of the reactive absorption column relative to the fluid inlet stream.

4. A method of purifying a carbon dioxide containing fluid inlet stream by removing NOₓ and SOₓ, comprising:
feeding the fluid inlet stream comprising carbon dioxide, NOₓ at a concentration of less than about 4000 ppm, and SOₓ to a single reactive absorption column; and
within the single reactive absorption column, removing at least a portion of the NOₓ and SOₓ to create a fluid outlet stream enriched in carbon dioxide and lean in SOₓ relative to the fluid inlet stream, and comprising a molar concentration of NOₓ that is at least about 20 times smaller than the molar concentration of NOₓ in the fluid inlet stream.

5. A method as in claim 1, further comprising feeding an acid condensate stream originating from a condenser unit upstream of the reactive absorption column to the reactive absorption column.

6. A method as in claim 1, wherein the pressure in the reactive absorption column is maintained between about 5 bar and about 50 bar.

7. A method as in claim 1, wherein the molar concentration of NOₓ in the fluid outlet stream is at least about 10 times smaller than the molar concentration of NOₓ in the fluid inlet stream.

8. A method as in claim 1, wherein the molar concentration of SOₓ in the fluid outlet stream is at least about 10 times smaller than the molar concentration of SOₓ in the fluid inlet stream.

9. (canceled)

10. A method as in claim 1, wherein the fluid inlet stream comprises NOₓ at a concentration of between about 100 ppm and about 4000 ppm.

11. (canceled)

12. A method as in claim 1, wherein the fluid inlet stream comprises an exhaust stream of an oxy-combustion process.

13. (canceled)

14. A method as in claim 1, wherein the fluid inlet stream further comprises a non-NOₓ, non-SOₓ contaminant.

15. A method as in claim 14, wherein the contaminant comprises a gas contaminant.

16. A method as in claim 15, wherein the gas contaminant comprises a non-condensable gas.

17. A method as in claim 14, wherein the contaminant comprises at least one of nitrogen (N₂), oxygen (O₂), carbon monoxide, and argon.

18-19. (canceled)

20. A method of purifying carbon dioxide, comprising:
feeding a fluid inlet stream comprising carbon dioxide and a contaminant to a distillation column to create a distillate stream comprising a first portion of the contaminant and a first portion of the carbon dioxide, wherein the distillate stream is enriched in the contaminant relative to the fluid inlet stream;
forming from the distillate stream a vapor stream comprising a second portion of the contaminant and a second portion of the carbon dioxide;
forming from the vapor stream a recycle stream comprising a third portion of the carbon dioxide; and
transporting at least a portion of the recycle stream to the distillation column.

21. A method of purifying carbon dioxide, comprising:
feeding a fluid inlet stream comprising carbon dioxide and a contaminant to a distillation column to create a distillate stream comprising a first portion of the contaminant and a first portion of the carbon dioxide, wherein the distillate stream is enriched in the contaminant relative to the fluid inlet stream;
forming from the distillate stream a vapor stream comprising a second portion of the contaminant and a second portion of the carbon dioxide;
forming from the vapor stream a recycle stream comprising a third portion of the carbon dioxide; and
performing a Joule-Thompson expansion of at least a portion of the recycle stream.

22-40. (canceled)

41. A system for purifying carbon dioxide, comprising:
a distillation column constructed and arranged to distill a fluid inlet stream comprising carbon dioxide and a contaminant to create a distillate stream comprising a first portion of the contaminant and a first portion of the carbon dioxide, wherein the distillate stream is enriched in the contaminant relative to the fluid inlet stream;
a first separator fluidically connected to the distillation column constructed and arranged to form from the distillate stream a vapor stream comprising a second portion of the contaminant and a second portion of the carbon dioxide;
a second separator fluidically connected to the first separator constructed and arranged to form from the vapor stream a recycle stream comprising a third portion of the carbon dioxide; and
a fluidic pathway constructed and arranged to transport at least a portion of the recycle stream to the distillation column.

42. A system for purifying carbon dioxide, comprising:
a distillation column constructed and arranged to distill a fluid inlet stream comprising carbon dioxide and a contaminant to create a distillate stream comprising a first portion of the contaminant and a first portion of the carbon dioxide, wherein the distillate stream is enriched in the contaminant relative to the fluid inlet stream;
a first separator fluidically connected to the distillation column constructed and arranged to form from the distillate stream a vapor stream comprising a second portion of the contaminant and a second portion of the carbon dioxide;
a second separator fluidically connected to the first separator constructed and arranged to form from the vapor stream a recycle stream comprising a third portion of the carbon dioxide; and
an expander fluidically connected to the second separator constructed and arranged to perform Joule-Thompson expansion of at least a portion of the recycle stream.

43-62. (canceled)

63. A method of combusting a fuel to produce a combustion exhaust stream and purifying carbon dioxide in the combustion exhaust stream, comprising:
feeding an air stream to an air separation unit to produce a fluid oxidizing stream comprising between about 92 mol % and about 95 mol % oxygen;
combusting a fuel in the presence of the fluid oxidizing stream within a combustor to produce a combustion exhaust stream comprising carbon dioxide; and
purifying the combustion exhaust stream to produce a carbon dioxide containing stream comprising at least about 90 mol % carbon dioxide;
wherein heat provided by the combustor is used to produce power from a power production unit, and
wherein the overall system efficiency is at least about 98% of the overall system efficiency of a power system without the at least one carbon dioxide purification unit, but under otherwise essentially identical conditions.

64. A method combusting a fuel to produce a combustion exhaust stream and purifying carbon dioxide in the combustion exhaust stream, comprising:
feeding an air stream to an air separation unit to produce a fluid oxidizing stream comprising between about 92 mol % and about 95 mol % oxygen;
combusting a fuel in the presence of the fluid oxidizing stream within a combustor to produce a combustion exhaust stream comprising carbon dioxide;
purifying the combustion exhaust stream to produce a carbon dioxide containing stream comprising at least about 90 mol % carbon dioxide;
wherein heat provided by the combustor is used to produce power from a power production unit, and
wherein the Rankine system efficiency is at least about 35%.

65-80. (canceled)
